(19) United States
(12) Patent Application Publication
(10) Pub. No.: US 2026/0006145 A1
(43) Pub. Date: Jan. 1, 2026

(54) IMAGE PROCESSING DEVICE, CONTROL METHOD, AND PROGRAM

(71) Applicant: CANON KABUSHIKI KAISHA, Tokyo (JP)

(72) Inventor: MIHO WATANABE, Tokyo (JP)

(21) Appl. No.: 19/209,888

(22) Filed: May 16, 2025

(30) Foreign Application Priority Data
Jul. 1, 2024 (JP) 2024-105923

(51) Int. Cl. H04N 1/32; G06K 15/00

(52) U.S. Cl. CPC H04N 1/32657; G06K 15/4085; H04N 1/3263; H04N 2201/0094

(57) ABSTRACT

An image processing device includes a jam occurrence record display unit configured to display a screen of records of jams at at least one location in the image processing device, and a jam details display unit configured to display details of individual records of jams that have occurred at the same location on the basis of a user operation on the screen of records of jams. At least one of the jam occurrence record display unit and the jam details display unit displays at least one of dates and times when the jams have occurred and paper information about the paper on which the jams have occurred.

### BACKGROUND

### Field of the Invention

The present invention relates to an image processing device, a control method, and a program.

### Description of the Related Art

There is a technique of notifying a serviceman of the necessity of maintenance if paper jams (hereinafter referred to as “jams”) frequently occur in an image processing device such as a multifunction device or a printer. This technique allows the serviceman to respond appropriately to the jams in accordance with the notification. In addition, a technique of adding information useful for maintenance for preventing occurrence of jams to such notifications supplementarily is known.

For example, Japanese Patent Laid-Open No. 2011-141797 discloses a management device in which, if a change satisfying a predetermined condition occurs in a usage environment including a temperature, a humidity, counter information such as the number of printed pages, and the like, occurrence of a problem is notified along with supplementary information about the changed usage environment. The supplementary information helps a serviceman in performing maintenance. In addition, the change in the usage environment is detected by measuring a temperature, a humidity, and the like inside and outside an image processing device using a temperature sensor, a humidity sensor, and the like.

However, the above-described management device may not be able to notify the supplementary information necessary for the serviceman to identify the cause of a jam.

### SUMMARY

Thus, an object of the present invention is to provide an image processing device, a control method, and a program in which it is possible to allow a serviceman to accurately identify the cause of a jam that has occurred in an image processing device.

In order to solve the above-described problems, an image processing device of the present invention includes: a jam occurrence record display unit configured to display a screen of records of jams at at least one location in the image processing device; and a jam details display unit configured to display details of individual records of jams that have occurred at the same location on the basis of a user operation on the screen of records of jams. At least one of the jam occurrence record display unit and the jam details display unit displays at least one of dates and times when the jams have occurred and paper information about the paper on which the jams have occurred.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example of a system configuration of an image processing system.

FIG. 2 is a diagram showing an example of a hardware configuration of an image processing device.

FIG. 3 is a diagram showing an example of a processing function showing a function relating to a first embodiment among processing units of the image processing device.

FIG. 4 is a diagram showing an example of a top screen of a state monitor.

FIG. 5 is a diagram showing an example of the top screen of the state monitor.

FIG. 6 is a diagram showing an example of a parts life screen.

FIG. 7 is a diagram showing an example of a state details screen.

FIG. 8 is a diagram showing an example of a trouble detection screen.

FIG. 9 is a diagram showing an example of a dirt details screen.

FIG. 10 is a diagram showing an example of an error screen.

FIG. 11 is a diagram showing an example of an error details screen.

FIG. 12 is a diagram showing an example of a jam screen.

FIG. 13 is a diagram showing an example of a jam details screen.

FIG. 14 is a diagram showing an example of a usage state screen.

FIG. 15 is a diagram showing an example of the usage state screen.

FIG. 16 is a diagram showing an example of the usage state screen.

FIG. 17 is a diagram showing an example of the usage state screen.

FIG. 18 is a diagram showing an example of parts life record data.

FIG. 19 is a diagram showing an example of trouble detection record data.

FIG. 20 is a diagram showing an example of record data of errors.

FIG. 21 is a diagram showing an example of record data of jams.

FIG. 22 is a diagram showing an example of usage state record data.

FIG. 23 is a diagram showing an example of usage state record data.

FIG. 24 is a diagram showing an example of usage state record data.

FIG. 25 is a diagram showing an example of usage state record data.

FIG. 26 is a flowchart showing an example of a startup of the state monitor top screen.

FIG. 27 is a flowchart showing an example of the startup of the state monitor top screen.

FIG. 28 is a flowchart showing an example of the startup of the state monitor top screen.

FIG. 29 is a flowchart showing an example of screen transitions to the state monitor top screen and each details screen.

FIG. 30 is a flowchart showing an example of screen transitions to the state monitor top screen and each details screen.

FIG. 31 is a flowchart showing an example of screen transitions to the state monitor top screen and each details screen.

FIG. 32 is a flowchart for describing a process of storing a jam occurrence record.

FIG. 33 is a flowchart for describing a process of displaying the jam screen and the jam details screen.

FIG. 34 is a flowchart for describing a display process of a jam screen according to a second embodiment.

FIG. 35 is a diagram showing that a record of locations mapped to a cross-sectional view of the image processing device is displayed at the top in the jam screen in the second embodiment.

FIG. 36 is a flowchart for describing a display process of a jam screen according to a third embodiment.

FIG. 37 shows that a serviceman selects any of the icons mapped to the cross-sectional view of the image processing device in the jam screen to display the record of the jam that has occurred at the selected location in the third embodiment.

### DESCRIPTION OF THE EMBODIMENTS

Aspects for implementing the present invention will be described below with reference to the drawings.

### First Embodiment

### <System Configuration>

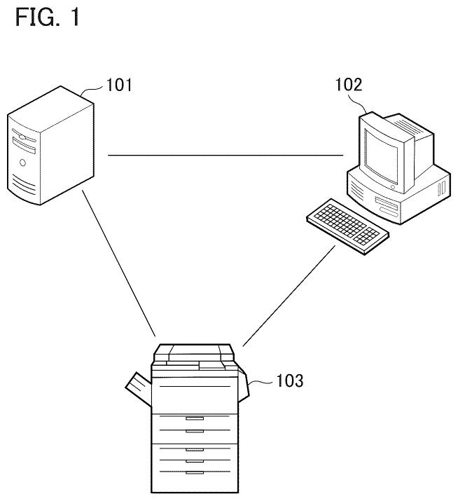

FIG. 1 is a diagram showing an example of a system configuration of an image processing system. The system according to a first embodiment includes an image processing device 103 connected to a network, a server personal computer (PC) 101 serving as an information processing device, and a client PC 102 serving as an information processing device.

The image processing device 103 is a multifunctional peripheral (MFP). The image processing device 103 has not only a function of copying paper documents, but also a function of printing print data sent from an external printer driver, and a function of sending image data generated by reading paper documents to an external file server or e-mail address (SEND function). In addition, the image processing device 103 has a function of transmitting data to another image processing device and printing it at the destination image processing device (remote copy function or facsimile function), or the like.

In the first embodiment, the image processing device 103 is connected by Ethernet (registered trademark) (not shown), but is not limited to this. Also, in the first embodiment, the server PC 101 and the client PC 102 other than the image processing device 103 may all be configured as the same computer. Alternatively, the server PC 101 and client PC 102 may be mounted on the image processing device 103, and the system may be configured only by the image processing device 103. Also, the information processing device used in the first embodiment may not be a PC, and may be a terminal device, a smartphone, or the like. Further, a printing method of the image processing device 103 may be, for example, an electrophotographic method, an inkjet method, or another method.

### <Hardware Configuration of Image Processing Device>

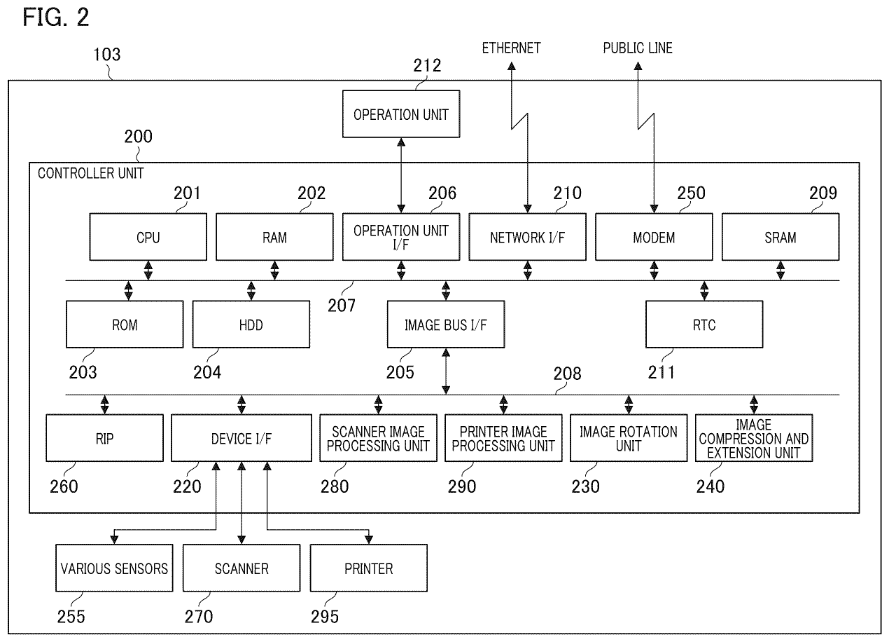

FIG. 2 is a diagram showing an example of a hardware configuration of the image processing device. A controller unit 200 is connected to a scanner 270 serving as an image input device, and a printer 295 serving as an image output device. Also, the scanner 270 is an example of a document reading unit for reading documents, and the printer 295 is an example of a printing unit for printing images on print media on the basis of image data. In addition, the controller unit 200 is connected by Ethernet (registered trademark), a public line, or the like, and executes input and output of image information, device information, or the like.

A central processing unit (CPU) 201 is a controller that controls the image processing device 103. In addition, the CPU 201 operates as a frequent jam occurrence location determination unit and a jam occurrence location determination unit. The frequent jam occurrence location determination unit determines whether or not there is a location at which jams have occurred more than a predetermined number of times. The jam occurrence location determination unit determines whether or not there is a location at which a jam is currently occurring. Also, specific examples of the frequent jam occurrence location determination unit and the jam occurrence location determination unit will be described later.

A random access memory (RAM) 202 is a system work memory for allowing the CPU 201 to operate, and is also an image memory for temporarily storing image data. A read only memory (ROM) 203 is a boot ROM, in which a boot program of the system is stored. A hard disk drive (HDD) 204 stores system software, applications, image data, and the like.

An operation unit I/F 206 is an interface unit with an operation unit 212 having a touch panel, and outputs image data to be displayed on the operation unit 212 to the operation unit 212. In addition, the operation unit I/F 206 transmits information input by a user of the system using the operation unit 212 to the CPU 201. A network I/F is connected to a network and performs input and output of information. A modem 250 is connected to a public line and performs input and output of information.

A static random access memory (SRAM) 209 is a non-volatile recording medium capable of high-speed operation. A real time clock (RTC) 211 executes a process of continuing to count a current time even if the controller unit 200 is not powered on. As shown in FIG. 2, the above devices are disposed on a system bus 207.

An image bus I/F 205 is a bus bridge that connects the system bus 207 to an image bus 208, which transfers image data at high speed, and converts a data structure. The image bus 208 is compliant with the peripheral component interconnect (PCI) bus or IEEE 1394.

A raster image processor (RIP) develops page description language (PDL) codes into bitmap images. A device I/F 220 is connected to various sensors 255 to acquire a device state. In addition, the device I/F 220 connects the scanner 270 and the printer 295, which are image input and output devices, to the controller unit 200 to perform synchronous or asynchronous conversion of image data. A scanner image processing unit 280 performs correction, processing, and editing of input image data. A printer image processing unit 290 performs printer correction, resolution conversion, and the like on print output image data. An image rotation unit 230 performs rotation of image data. An image compression and decompression unit 240 performs the compression and decompression process. As shown in FIG. 2, the above devices are disposed on the image bus 208.

### <Software Configuration of Image Processing Device>

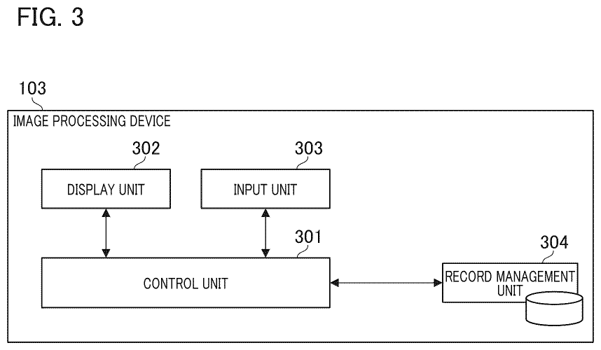

FIG. 3 is a diagram showing an example of a processing function showing a function relating to the first embodiment among processing units of the image processing device. As described with reference to FIG. 2, the CPU 201 executes some or all of programs on the RAM 202 on the basis of the programs stored in the ROM 203, thereby realizing functions of the processing units and processes relating to the flowcharts described below.

A display unit 302 has a function of displaying a state and an operation menu of the image processing device 103 on the operation unit 212. An input unit 303 has a function of accepting operation instructions from the user. A record management unit 304 has a function of processing information and storing the state and a usage record of the image processing device 103 in a record DB. A control unit 301 has a function of controlling the display unit 302, the input unit 303, and the record management unit 304.

Also, the control unit 301 and the display unit 302 operate as a jam occurrence record display unit and a jam details display unit. The jam occurrence record display unit displays records of jams that have occurred when documents were read. The jam details display unit displays details of individual records of jams that have occurred at the same location. In addition, if it is determined that there is a location at which jams have occurred more than a predetermined number of times, the jam occurrence record display unit visualizes the location at which the jams have occurred more than a predetermined number of times. On the other hand, if it is determined that there is a location at which a jam is currently occurring, the jam occurrence record display unit visualizes the location at which the jam is currently occurring. At least one of the jam occurrence record display unit and the jam details display unit displays at least one of dates and times when jams have occurred and paper information about the paper on which the jams have occurred.

Also, the jam occurrence record display unit may display only the latest record at the location at which jams have occurred or at which a jam is currently occurring. In addition, if an instruction to specify the location at which jams have occurred or at which a jam is currently occurring and to display a record other than the latest record is detected, the jam occurrence record display unit may display individual records of the jams at the location relating to the instruction.

Also, the jam occurrence record display unit may display only the latest record at the location at which jams have occurred or at which a jam is currently occurring. In addition, if an operation on a display area is detected in which information about the location at which jams have occurred more than a predetermined number of times or the location at which a jam is currently occurring is displayed, the jam occurrence record display unit may display individual records of the jams at the location relating to the operation.

Also, the jam occurrence record display unit may display jam record information indicating records of jams in the order of the date and time when each jam occurred.

Also, the jam occurrence record display unit may display jam record information indicating records of jams at visualized locations at the top among the locations at which jams have occurred more than a predetermined number of times and at the location at which a jam is currently occurring.

Also, the jam occurrence record display unit may display at least one of the location at which jams are determined to have occurred more than a predetermined number of times and at which a jam is determined to be currently occurring using an icon superimposed on a diagram of the image processing device 103.

Also, if there is no location at which jams are determined to have occurred more than a predetermined number of times and no location at which a jam is determined to be currently occurring, the jam occurrence record display unit may not display anything on the diagram of the image processing device.

Also, if there is no location at which jams are determined to have occurred more than a predetermined number of times, the jam occurrence record display unit may display that there is no location at which jams are determined to have occurred more than a predetermined number of times, and may not display a location at which jams have occurred more than a predetermined number of times.

Also, if there is no location at which a jam is determined to be currently occurring, the jam occurrence record display unit may display that there is no location at which a jam is determined to be currently occurring, and may not display a location at which a jam is currently occurring.

Also, details of the jam occurrence record display unit and the jam details display unit will be described later.

### <Screen Configuration of First Embodiment>

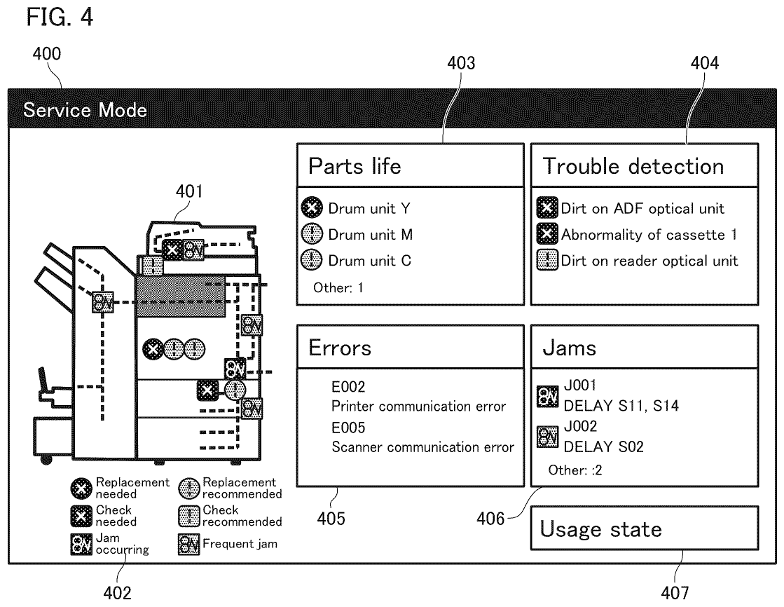

Next, a state monitor screen that displays the state and record of the image processing device 103 for the serviceman will be described with reference to FIGS. 4 to 17. The state monitor screen is a screen that is displayed on the operation unit 212 of the image processing device 103, but is not intended for general users and is only started by a special operation. Also, each of screens shown in FIGS. 4 to 17 is displayed on the basis of data recorded in the record management unit 304.

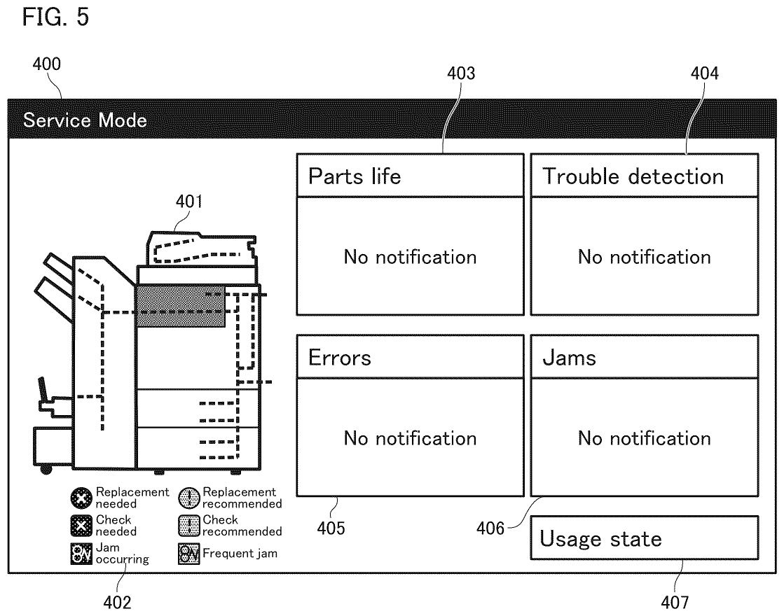

FIGS. 4 and 5 are diagrams showing examples of a top screen of a state monitor. Specifically, FIG. 4 shows an example of a top screen 400 if there is an abnormality in the image processing device 103. Also, specifically, FIG. 5 shows an example of the top screen 400 if there is no abnormality in the image processing device 103.

As shown in FIG. 4, a cross-sectional view 401 of the image processing device 103 shows a mapping display of abnormality occurrence locations and their types in the image processing device 103 on the cross-sectional view using icons. The cross-sectional view 401 also shows a paper transport path, and can inform the serviceman whether or not there is an abnormality that may affect use of main functions of the image processing device 103, such as scanning and printing.

A legend 402 for types of abnormality indicates types and contents for the icons mapped and displayed on the cross-sectional view 401. The types indicate a location at which a deteriorated part needs to be replaced, a location at which a check is needed due to occurrence of a problem, a location at which jams have occurred, a location at which jams have occurred more than a predetermined number of times, and the like.

A parts life 403, a trouble detection 404, errors 405, and jams 406 are areas for notifying the user of abnormalities occurring in the image processing device 103, and are buttons that are pressed to transition to a details screen of the notified content. Since the contents that can be displayed in the notification areas for each abnormality for each of the parts life 403, the trouble detection 404, the errors 405, and the jams 406 are all limited by sizes of the areas, they are displayed in descending order of priority of abnormality, and if there are abnormalities that cannot be displayed, only the number is displayed.

The priority in the parts life 403 is higher for parts that need to be replaced than for parts that are recommended to be replaced. Also, if the priorities are at the same level, the parts life 403 displays them in accordance with an arrangement order of a parts life screen, which will be described later. The priority in the trouble detection 404 is higher for troubles that need to be checked than for troubles that are recommended to be checked. Also, if the priorities are at the same level, the trouble detection 404 displays them in accordance with an arrangement order of a trouble detection screen, which will be described later. The errors 405 displays only currently occurring errors in descending order of the occurrence date and time. The priority in the jams 406 is higher for a location at which a jam is currently occurring than for a location at which jams have occurred more than a predetermined number of times. Also, if the priorities are at the same level, the jams 406 are displayed in descending order of the occurrence date and time, as in a jam screen, which will be described later.

As shown in FIG. 4, the parts life 403 indicates, using the icons displayed in the legend 402, that a drum unit Y needs to be replaced and that a drum unit M and a drum unit C are approaching the time to replace them and are recommended to be replaced. As shown in FIG. 4, the parts life 403 indicates that there is one part that is approaching the end of its life. If the parts life 403 or a button at its top is pressed, the screen shown in FIG. 4 transitions to the parts life screen, which will be described later.

As shown in FIG. 4, the trouble detection 404 indicates, using the icons displayed in the legend 402, that there are two troubles which need to be checked and one trouble which is recommended to be checked. If the trouble detection 404 or a button at its top is pressed, the screen shown in FIG. 4 transitions to the trouble detection screen, which will be described later.

As shown in FIG. 4, the errors 405 indicates that there are two errors that are occurring. Also, since it is difficult to appropriately display many system-related errors at specific positions on a diagram such as a cross-sectional view of the image processing device 103, the errors 405 does not display the icons shown in the legend 402. If the errors 405 or a button at its top is pressed, the screen shown in FIG. 4 transitions to an error screen, which will be described later.

As shown in FIG. 4, the jams 406 indicates that there is one location at which a jam is currently occurring and two locations at which jams have occurred more than a predetermined number of times. If the jams 406 or a button at its top is pressed, the screen shown in FIG. 4 transitions to the jam screen, which will be described later. A usage state 407 is a button that is pressed to transition the screen shown in FIG. 4 to the usage state screen, which will be described later.

The top screen 400 shown in FIG. 5 does not display the icons shown in the legend 402 because there is no abnormality in the image processing device 103. That is, the parts life 403, the trouble detection 404, the errors 405, and the jams 406 are all displayed as “No notification,” and thus the serviceman can recognize at a glance that no abnormality has occurred.

Also, the top screen 400 shown in FIG. 4 and the top screen 400 shown in FIG. 5 can inform the serviceman of the presence or absence of abnormalities in the image processing device 103, locations at which the abnormalities occurred, a location at which an abnormality is currently occurring, and the contents of the abnormalities. For this reason, the top screen 400 shown in FIG. 4 and the top screen 400 shown in FIG. 5 can allow the serviceman to quickly identify the areas that need to be addressed and to immediately begin work, In addition, the top screen 400 shown in FIG. 4 and the top screen 400 shown in FIG. 5 can allow the serviceman to consider efficient work procedures, such as treating abnormalities in locations close to each other on the cross-sectional view 401 together.

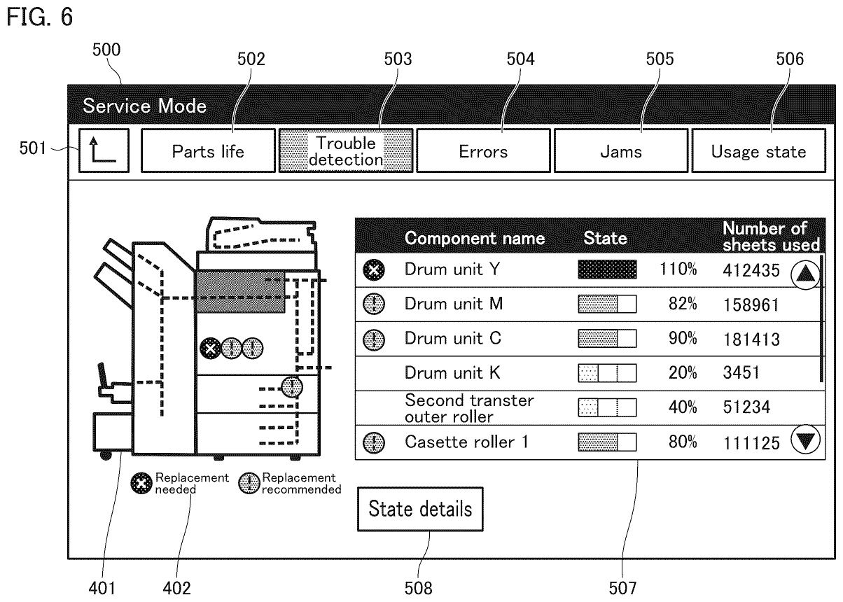

FIG. 6 is a diagram showing an example of the part life screen. The parts life screen 500 shown in FIG. 6 is displayed if the parts life 403 on the top screen 400 is pressed. The parts life screen 500 displays a back to top screen button 501, a parts life button 502, a trouble detection button 503, an error button 504, a jam button 505, and a usage state button 506 at its top. These six buttons are pressed to switch screens. In addition, these six buttons are also displayed on each details screen, which will be described later, and thus the serviceman can easily switch between the respective details screens. Accordingly, these six buttons can allow the serviceman to easily perform the task of comparing the information displayed on the respective details screens and inferring the cause of the abnormality.

The parts life screen 500 also displays the cross-sectional view 401 and the legend 402, but only displays icons for replacement parts. A parts list 507 displays a list of states of replacement parts. The parts list 507 displays, on each line, a component name of a part, a state, and the number of sheets used that have been passed through after replacement. In addition, the state is displayed in four steps corresponding to a state value of a component. These four steps are level 0, which is immediately after part replacement and in which the state value is indefinite, level 1, in which the state value is 0 to 79%, level 2, in which the state value is 80 to 99%, and level 3, in which the state value is 100% or more. These four steps are displayed with a level meter icon. Also, the state value is displayed as a number to the right of the level meter icon. The state value is preset so that it increases as deterioration of a part progresses and a value at which the part needs to be replaced is 100%. As parameters used to calculate the state value, for example, the number of sheets used after replacement, a current value of each part, and a resistance value of each part are used.

If the state value of a part is level 2, the parts list 507 displays an icon indicating that the part is recommended to be replaced, indicating that the part is approaching the end of its life. In the example shown in FIG. 6, the parts list 507 indicates that “Drum unit M,” “Drum unit C,” and Cassette roller 1” are recommended to be replaced.

If the state value of a part is level 3, the parts list 507 displays an icon indicating that the part needs to be replaced, indicating that the part has reached the end of its life. In the example shown in FIG. 6, the parts list 507 indicates that “Drum unit Y” needs to be replaced.

If the part is replaced by the serviceman and the replacement of the part is detected, the state value once returns to level 0, which means no data. For this reason, the parts list 507 does not display the icon indicating that the part needs to be replaced and the icon that the part is recommended to be replaced in the cross-sectional view 401 and the parts list 507.

Unlike the notification areas for the parts life 403 on the top screen 400, the parts list 507 displays all parts managed by the serviceman, regardless of the presence or absence of an abnormality. For this reason, the parts list 507 allows the serviceman to check the state values of the parts that do not yet need to be replaced. The parts list 507 may display all parts by, for example, scrolling up and down. A state details button 508 is a button that is pressed to transition to a state details screen 510, which displays a graph of a change in a state value of a part selected in the parts list 507.

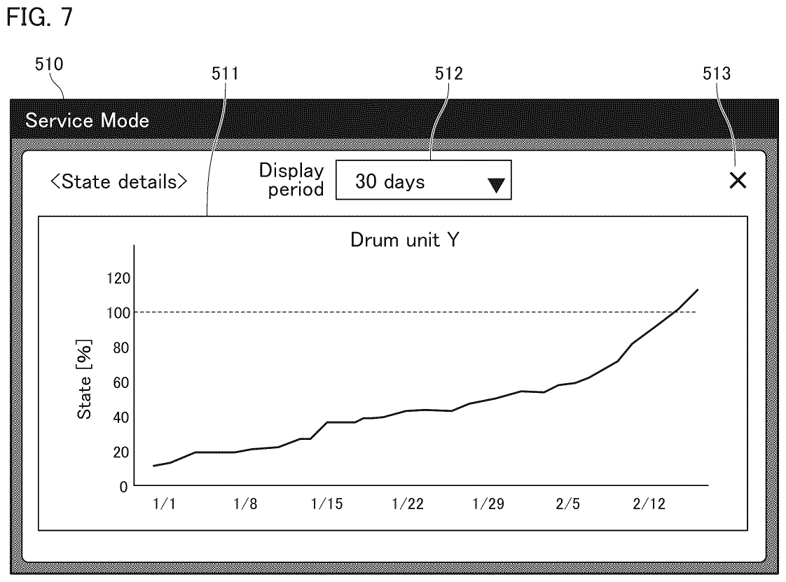

FIG. 7 is a diagram showing an example of the state details screen. Specifically, FIG. 7 shows the state details screen 510 that is displayed when the state details button 508 is pressed. As shown in FIG. 7, the state details screen 510 displays a state change graph 511, a display period 512, and a close button 513.

The state change graph 511 shows a daily change of the state value of the selected part. In addition, the state change graph 511 shows a reference line at 100%, at which the part needs to be replaced. The display period 512 is a pull-down menu that switches a display period of the graph between 30 days and 180 days. The close button 513 is a button that is pressed to close the state details screen 510 and return to the parts life screen 500.

In the example shown in FIG. 7, the state change graph 511 shows the daily change of the state value of “Drum unit Y” on the parts life screen 500, showing the daily change of the state value reaching over 100%. Thus, the state change graph 511 can help the serviceman recognize whether deterioration of the part is progressing as expected or deterioration of the part is progressing rapidly due to a change in the environment, a defect of the part, or the like.

Also, in the example shown in FIG. 7, an example in which the state value exceeds 100% and the part has reached the end of its life is shown. However, even if the state value is less than 100% and the part has not yet reached the end of its life, the state change graph 511 can help the serviceman predict the timing when the part will reach the end of its life on the basis of a slope of the graph. Accordingly, the state change graph 511 can help the serviceman determine whether or not to bring a part for replacement the next time maintenance will be performed on the image processing device 103.

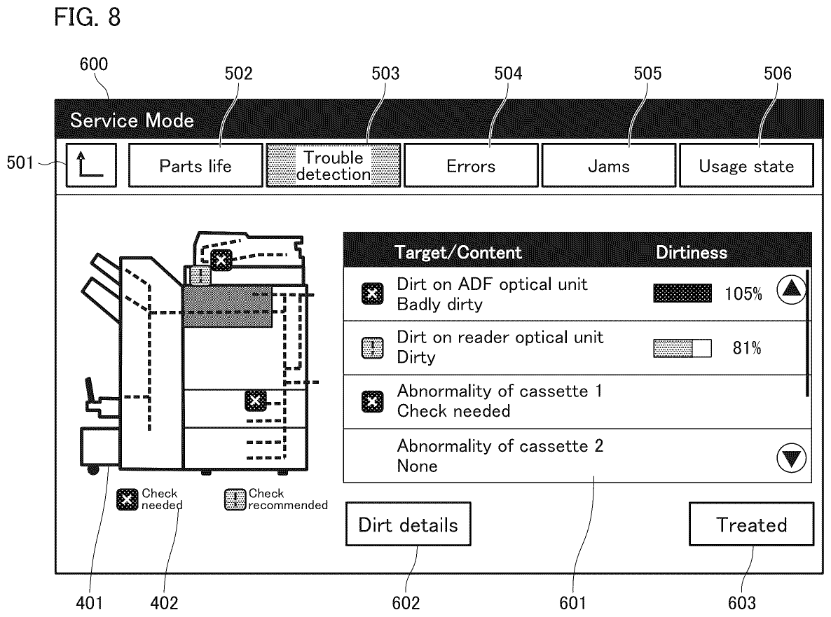

FIG. 8 is a diagram showing an example of the trouble detection screen. The trouble detection screen 600 shown in FIG. 8 is displayed if the trouble detection 404 displayed on the top screen 400 is pressed or if the trouble detection button 503 displayed on each details screen is pressed. Like the parts life screen 500, the trouble detection screen 600, displays the back to top screen button 501, the parts life button 502, the trouble detection button 503, the error button 504, the jam button 505, and the usage state button 506 at its top. The trouble detection screen 600 also displays the cross-sectional view 401 and the legend 402, but only displays the icon indicating that a trouble check is needed and the icon indicating that a trouble check is recommended.

A trouble list 601 displays a list of troubles that are relatively frequently required to be addressed by the serviceman and the contents of the troubles. “Dirt on ADF optical unit” and “Dirt on reader optical unit” shown in FIG. 8 indicate whether cleaning of the optical unit is needed or cleaning of the optical unit is recommended.

If a degree of dirt on a mirror is detected on the basis of a value relating to reflected light from the mirror acquired by an optical sensor, or the like, the trouble list 601 indicates whether or not treatment is needed. That is, in this case, like the state value of the parts life, the trouble list 601 displays whether or not treatment is needed using the level meter icon with the four steps and a value of dirtiness in which a reference value indicating that cleaning is needed is set to 100%.

The trouble list 601 displays a level 2 icon if the dirtiness is 80 to 99%, and a level 3 icon if the dirtiness is 100% or greater. In addition, the trouble list 601 displays a check recommended icon indicating that cleaning is recommended at a left end of the list if the dirtiness is level 2, and a check required icon indicating that cleaning is needed if the dirtiness is level 3. Further, the trouble list 601 switches messages displayed in each list in accordance with a dirtiness level. For example, the trouble list 601 displays messages of “No data” for level 0, “Good” for level 1, “Dirty” for level 2, and “Badly dirty” for level 3.

A dirt details button 602 is a button that is pressed when the list relating to the dirt on the optical unit is selected, and is used for checking a graph of a change in the dirtiness.

For cassette abnormality, the trouble list 601 displays whether or not there is an abnormality in each cassette and the content of the abnormality. The cassette abnormality is mainly detected if a misalignment of a paper regulator (guide) in a cassette is detected. The trouble list 601 displays a message saying “Check required” in the list if there is a cassette abnormality, and displays a message saying “None” in the list if there is no cassette abnormality.

A treated button 603 is a button that can be pressed if the optical unit or cassette needs to be checked or is recommended to be checked. After the optical unit has been cleaned, if the treated button 603 is pressed with the optical unit selected, the dirtiness level returns to 0. In this case, the icon indicating that the trouble check is needed and the icon indicating that the trouble check is recommended are not displayed on the cross-sectional view 401 and the trouble list 601. After the cassette has been checked, if the treated button 603 is pressed with the optical unit selected, the display returns to show that there is no abnormality. In this case, the icon indicating that the trouble check is needed is not displayed on the cross-sectional view 401 and the trouble list 601.

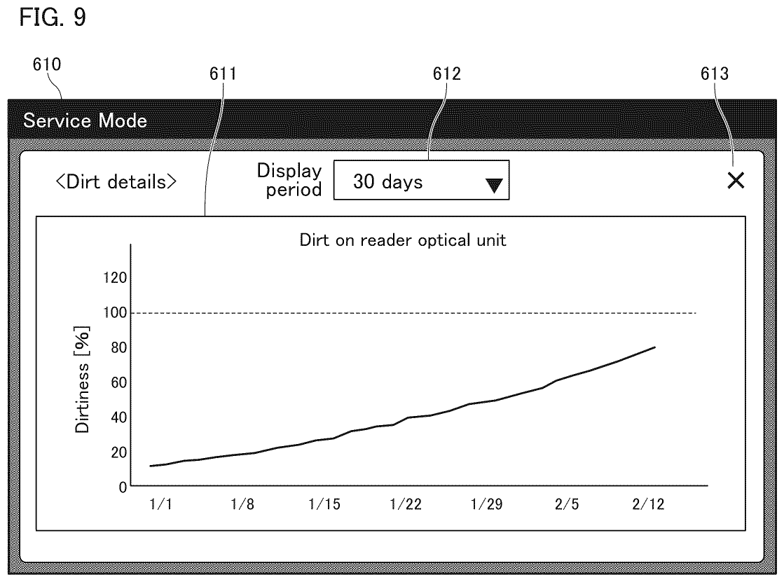

FIG. 9 is a diagram showing an example of a dirt details screen. A dirt details screen 610 is displayed if the dirt details button 602 is pressed. A dirt change graph 611 shows a daily change in the dirtiness of the selected optical unit. The dirt change graph 611 displays a reference line indicating 100%, which is the dirtiness at which cleaning is needed. A display period 612 is a pull-down menu for switching a display period of the dirt change graph 611 between 30 days and 180 days. A close button 613 is a button that is pressed to close the dirt details screen 610 and return to the trouble detection screen 600.

In the example shown in FIG. 9, the dirt change graph 611 for “Dirt on reader optical unit” displayed on the trouble detection screen 600 is shown, and a daily change up to the day reaching 81%, which is a dirtiness that is recommended to be checked, is shown. The dirt change graph 611 can help the serviceman predict the timing when cleaning is needed on the basis of a slope of the graph. In addition, due to this, the dirt change graph 611 can help the serviceman determine whether or not to bring along tools required for cleaning the next time maintenance will be performed on the image processing device 103.

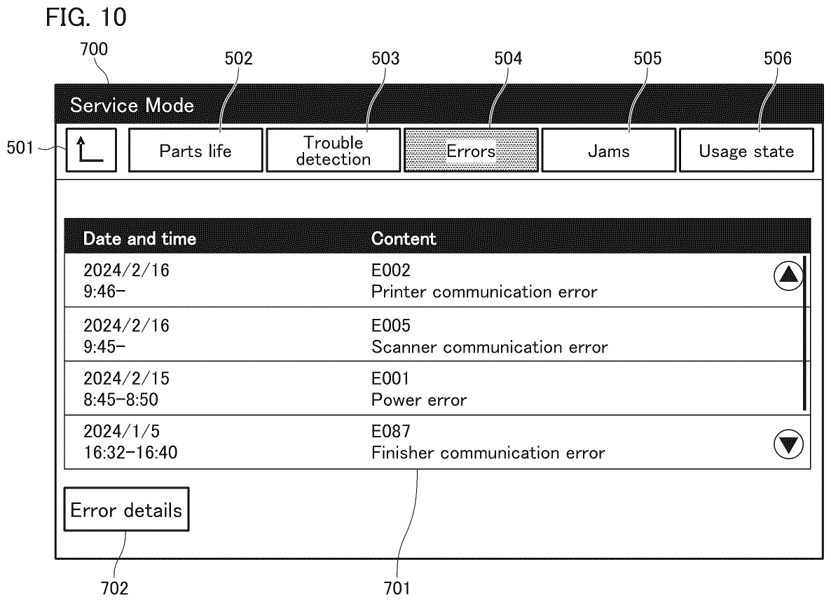

FIG. 10 is a diagram showing an example of an error screen. An error screen 700 is displayed if the errors 405 displayed on the top screen 400 is pressed or if the error button 504 displayed on each details screen is pressed. The top screen 400 displays the back to top screen button 501, the parts life button 502, the trouble detection button 503, the error button 504, the jam button 505, and the usage state button 506. All of these six buttons are the same as the buttons displayed on the parts life screen 500 shown in FIG. 6.

An error list 701 displays a list of error records that occurred in the image processing device 103. An error record includes an error occurrence date, an error occurrence time, a recovery time, an error code, and an error title for each error. Also, the error list 701 does not display the return time for errors that are still occurring, as shown in the first and second lines of FIG. 10. An error details button 702 is pressed to check detailed information about the errors included in the error list 701. In addition, the error details button 702 is pressed when the error record is selected.

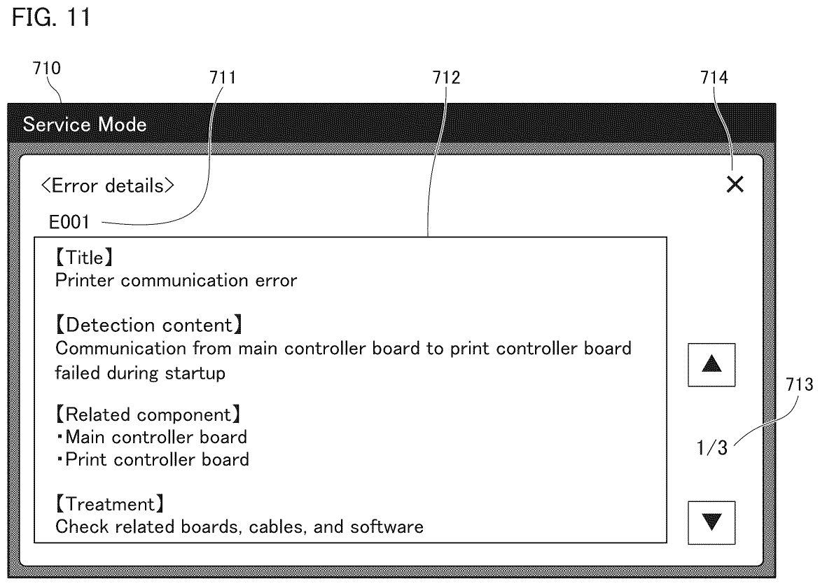

FIG. 11 is a diagram showing an example of an error details screen. An error details screen 710 displays an error code 711, error information 712, a page forward button 713, and a close button 714. The error code 711 is a code for identifying the selected error. The error information 712 includes titles, descriptions, treating methods of the errors, and the like. The page forward button 713 is a button for switching pages if the error information 712 spans a plurality of pages. The close button 714 is a button that is pressed to close the error details screen 710 and return to the error screen 700. The error details screen 710 can help the serviceman recognize the error that is occurring and the content of the error.

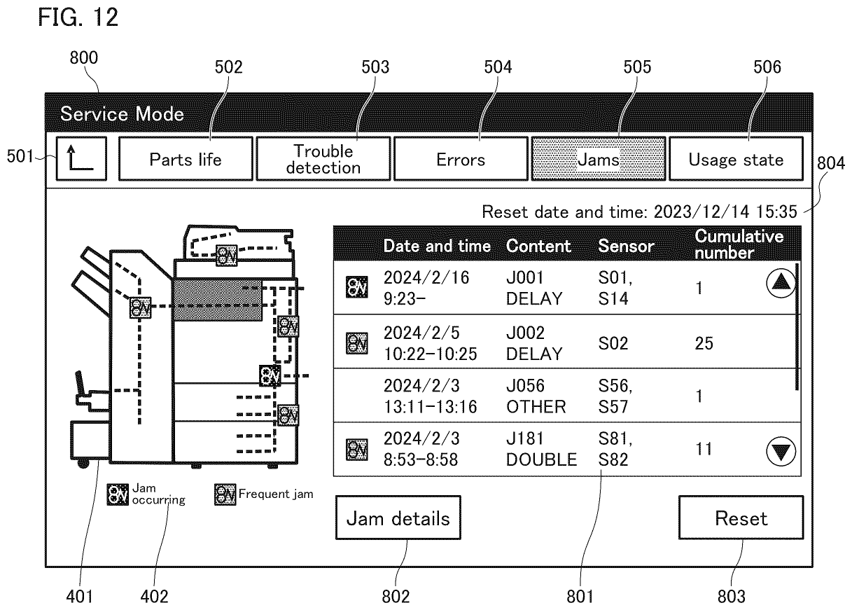

FIG. 12 is a diagram showing an example of a jam screen. A jam screen 800 is displayed if the jams 406 displayed on the top screen 400 or the jam button 505 displayed on each details screen is pressed. The jam screen 800 displays the back to top screen button 501, the parts life button 502, the trouble detection button 503, the error button 504, the jam button 505, and the usage state button 506. All of these six buttons are the same as the buttons displayed on the parts life screen 500 shown in FIG. 6.

The jam screen 800 also displays the cross-sectional view 401 and the legend 402, but as for the displayed icons, only displays the icons for a jam that is currently occurring and jams that have occurred more than a predetermined number of times. The jam screen 800 displays a jam list 801, a jam details button 802, a reset button 803, and a reset date and time 804.

The jam list 801 is a list of jam records. The jam list 801 includes a jam occurrence date, a jam occurrence time, a recovery time, a jam code, a jam type, a sensor number, and a cumulative number of jams that have occurred at each of specific locations set in the paper transport path. In the present example, the specific locations correspond to a plurality of respective sensors that are installed in the image processing device to detect occurrence of jams. Also, jams that have occurred at the specific locations are assigned with different jam codes for each location. That is, in the present example, the jam list 801 can be said to be a list of information about jams for each specific location set in the paper transport path, a list of information about jams for each sensor, or a list of information about jams for each jam code. In addition, for the jam that is still occurring, as shown in the first line of FIG. 12, the jam list 801 does not display the recovery time, but displays an icon indicating that a jam is still occurring at a left end of the list. Further, as shown in the second and fourth lines of FIG. 12, the jam list 801 determines the jam that has occurred more than a predetermined number of times as a frequent jam, and displays a frequent jam icon on the left end of the list. In the present embodiment, the icon displayed if a jam is currently occurring and the icon displayed if the frequent jam is occurring are identical in their marks, but they are displayed in different colors, such as red and yellow. In the example shown in FIG. 12, the jam that has occurred 10 or more times is determined to be the frequent jam. Also, if there are a plurality of records with the same jam code, the jam list 801 displays only the latest one for the records for the same jam code. Thus, the jam list 801 allows the serviceman to easily understand the type of jam that has occurred.

The jam details button 802 is a button that is pressed to check details of jams. Also, the jam details button 802 is pressed when a jam record is selected.

The reset button 803 is a button that is pressed to clear the jam record being displayed. The reset button 803 is pressed if check of the jam that is currently occurring, the jams that have occurred more than a predetermined number of times, and the like is completed and the notifications are to be deleted. If the reset button 803 is pressed, the date and time indicated by the reset date and time 804 is updated, and only the jam record after the reset date and time 804 is displayed in the jam list 801.

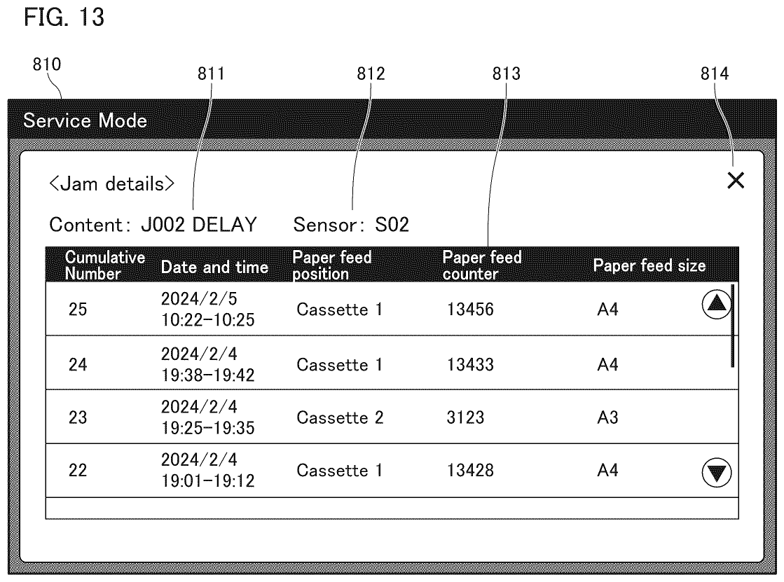

FIG. 13 is a diagram showing an example of a jam details screen. A jam details screen 810 is displayed if the jam details button 802 is pressed. The jam details screen 810 displays a jam content 811, a sensor number 812, a jam details list 813, and a close button 814.

The jam content 811 includes a jam code and a jam type selected on the jam list 801. The sensor number 812 is a sensor number associated with the jam code and a jam occurrence location.

The jam details list 813 is a list that displays jam records with the same jam content 811 in descending time-series order. The jam details list 813 includes a cumulative number, an occurrence date, an occurrence time, a recovery time, a paper feed position when a jam occurred, a paper feed counter from the paper feed position when the jam occurred, and a size of the fed paper. In the jam list 801, only the latest one of the jam records with the same jam code is displayed to show types of the jams that have occurred, but in the jam details list 813, an occurrence frequency of the same jam is easier to see. In addition, if there are a number of jams, the jam details list 813 may display details of all jams, for example, by scrolling up and down.

The close button 814 is a button that is pressed to close the jam details screen 810 and return to the jam screen 800.

The jam details screen 810 displays not only jams that are currently occurring, but also locations at which the number of jams that have occurred in the past has exceeded a predetermined number of times, occurrence frequencies of each jam, and the like. Thus, the jam details screen 810 can help the serviceman to consider cleaning or replacing of components around the locations such as the locations at which the jams are currently occurring or the locations at which the jams have occurred more than a predetermined number of times in the past.

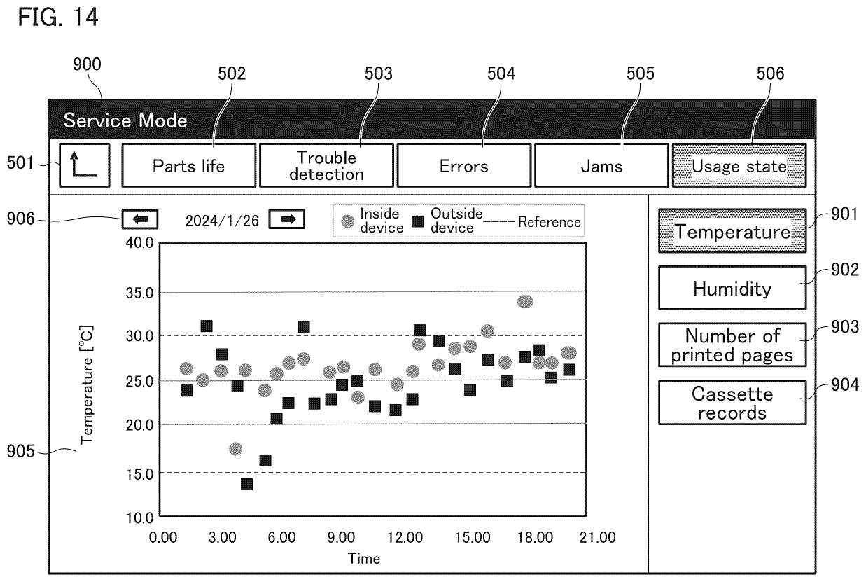

FIGS. 14 to 17 are diagrams showing examples of a usage state screen. A usage state screen 900 is displayed if the usage state 407 displayed on the top screen 400 is pressed or if the usage state button 506 displayed on each details screen is pressed. The usage state screen 900 displays, on its right side, a temperature button 901, a humidity button 902, a print count button 903, and a cassette record button 904, which are pressed to transition to each screen of usage states. Since these four buttons are also displayed on each usage state screen, they allows the serviceman to easily switch each usage state screen.

Also, the usage state screen 900 displays the back to top screen button 501, the parts life button 502, the trouble detection button 503, the error button 504, the jam button 505, and the usage state button 506. Thus, the usage state screen 900 allows the serviceman to easily switch between the parts life screen 500, the trouble detection screen 600, and the usage state screen 900 using these six buttons. In addition, due to this, the usage state screen 900 allows the serviceman to easily infer the cause of a problem from trouble information and usage states.

FIG. 14 shows an example of a temperature change screen that is displayed if the temperature button 901 displayed on the usage state screen 900 is pressed. A temperature change graph 905 has a vertical axis representing temperature (° C.) and a horizontal axis representing time, and shows temperatures inside the device for one day and temperatures outside the device for one day at 10-minute intervals. A date switch button 906 is a button that is pressed to change the date to be displayed, and can display data up to one month ago, for example. In addition, since the temperature change graph 905 displays the reference with a dotted line, it can help the serviceman to determine that the environment needs to be reviewed if temperatures outside the reference are displayed. Further, it is possible for the serviceman to compare the period during which the abnormalities shown in FIGS. 6 to 13 were occurring with the temperature change screen shown in FIG. 14 to check whether or not the temperature change is the cause of component deterioration or jams.

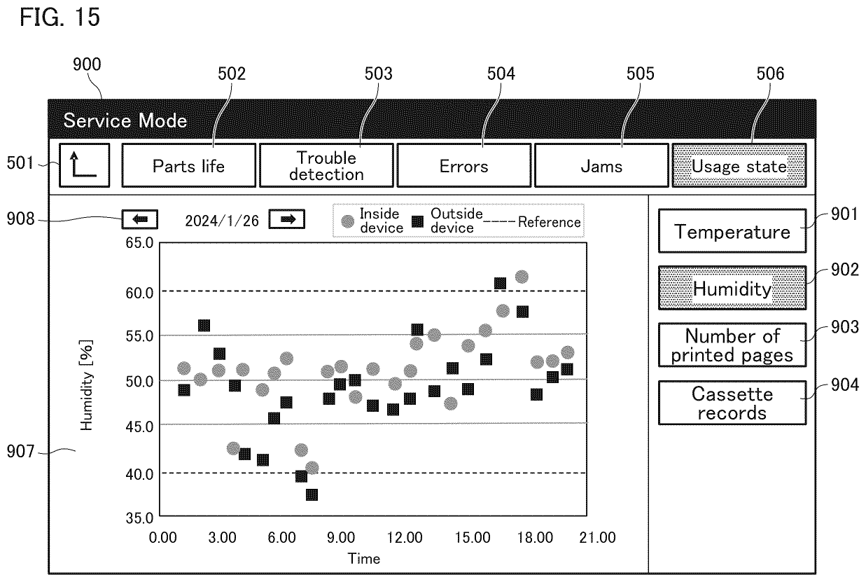

FIG. 15 shows an example of a humidity change screen that is displayed if the humidity button 902 displayed on the usage state screen 900 is pressed. A humidity change graph 907 has a vertical axis representing temperature (° C) and a horizontal axis representing time, and shows humidities inside the device for one day and humidities outside the device for one day at 10-minute intervals. A date switch button 908 is a button that is pressed to switch the date to be displayed, and can display data up to one month ago, for example. In addition, since the humidity change graph 907 displays the reference with a dotted line, it can help the serviceman to determine that the environment needs to be reviewed if humidities outside the reference are displayed. Further, it is possible for the serviceman to compare the period during which the abnormalities shown in FIGS. 6 to 13 were occurring with the humidity change screen shown in FIG. 15 to check whether or not the humidity change is the cause of component deterioration or jams.

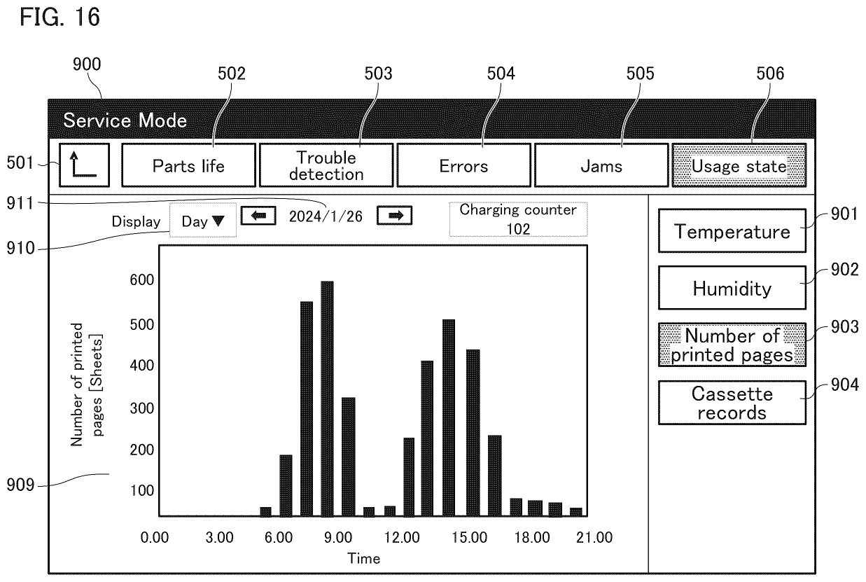

FIG. 16 shows an example of a print count screen that is displayed if the print count button 903 displayed on the usage state screen 900 is pressed. A print count graph 909 has a vertical axis representing the number of printed pages (sheets), and a horizontal axis representing time. A display period switch button 910 is a button that is pressed to change the display period in units of one month or one day. A date switch button 911 is a button that is pressed to switch the date to be displayed.

If “Month” is selected by the display period switch button 910, the print count screen displays data for one month at one-day intervals, and by selecting the date switch button, data for each month is switched and displayed. In addition, if “Day” is selected by the display period switch button 910, the print count screen displays data for one day at hourly intervals, and by selecting the date switch button, data for each day is switched and displayed.

For example, FIG. 6 shows that the end of a part's life is approaching earlier than expected on the parts life screen 500, and FIG. 16 shows that a large amount of printing has been done just before the part's life was about to end, using the print count graph 909. In this case, the serviceman can infer that the part's life is approaching earlier than expected due to the large amount of printing.

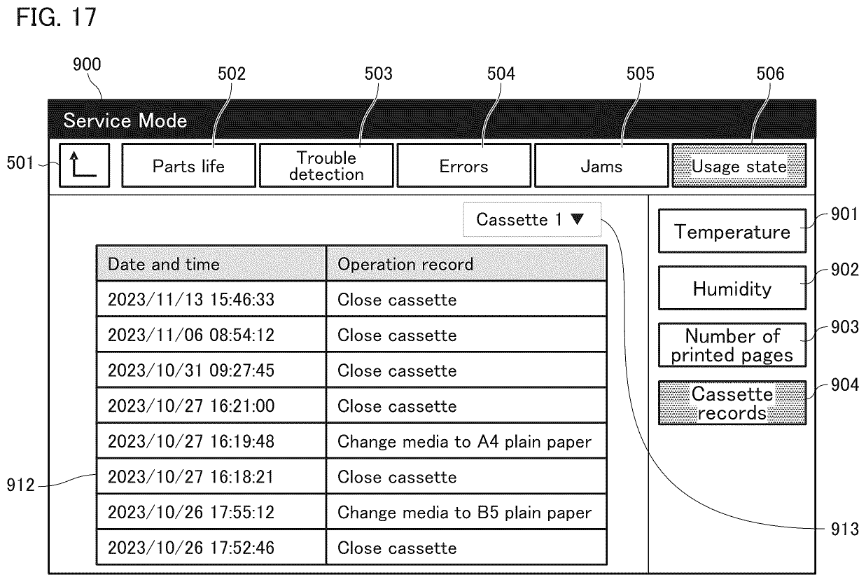

FIG. 17 shows an example of a cassette record screen that is displayed if the cassette record button 904 displayed on the usage state screen 900 is pressed. A cassette record list 912 displays a record of operations on a cassette in time-series order. A cassette switch button 913 is operated to select the cassette whose record is to be displayed.

For example, FIG. 6 shows that an abnormality in a cassette has been detected on the parts life screen 500, and the cassette record list 912 shown in FIG. 17 shows a record of operations on the cassette. In this case, the serviceman can infer that there is a possibility of frequent operations performed on the cassette becoming the cause of misalignment of a paper regulator (guide) of the cassette.

### <Configuration of Record Data of First Embodiment>

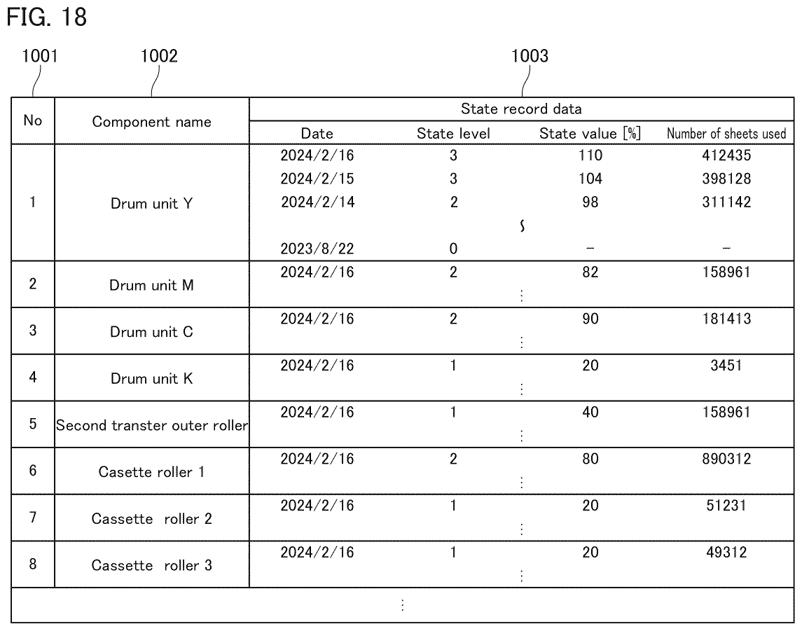

Next, with reference to FIGS. 18 to 25, the data recorded in the record management unit 304, which manages the data displayed on the state monitor screen described above, will be described. The record management unit 304 organizes values and settings acquired from the various sensors 255, the scanner 270 or the printer 295 via the device I/F 220 shown in FIG. 2 into necessary information and stores it in the HDD 204 or RAM 202.

FIG. 18 is a diagram showing an example of parts life record data. A column 1001 is a column showing numbers of components in arrangement order. A column 1002 is a column showing component names. A column 1003 is a column showing record data of states of each component. The record data for the states of each component is daily data regarding the dates the data was acquired, the state values of a component, and the number of sheets of the paper used after the component was replaced. The state value of a component is a state level and a state value (%). A component with a state level of 3 is displayed as a component that needs to be replaced in the cross-sectional view 401 and the parts life 403 shown in FIG. 4. A component with a state level of 2 is displayed as a component that is recommended to be replaced in the cross-sectional view 401 and the parts life 403 shown in FIG. 4. Each of the parts and states of the parts shown in FIG. 18 are all displayed in the arrangement order of the column 1001 in the parts list shown in FIG. 6.

Also, the state record data is used to display the state change graph 511 shown in FIG. 7. Since the state record data has the display periods of 30 days and 180 days, data for at least 180 days is stored. If replacement of a component performed by the serviceman is detected, the state level of the replaced component becomes level 0, which is an indefinite state after the part has been replaced,. In addition, the state value (%) of the replaced part and the number of sheets used become none. As described above, the parts life record data shown in FIG. 18 is used to display the parts lives for each screen.

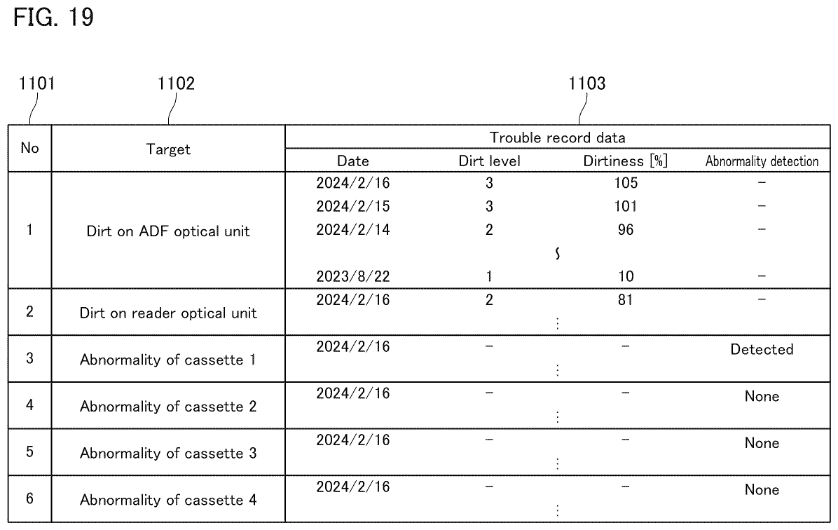

FIG. 19 is a diagram showing an example of trouble detection record data. A column 1101 is a column showing numbers of troubles in the arrangement order. A column 1102 is a column showing names of objects. A column 1103 is a column showing record data for each trouble. If the component is an optical unit, the record data for each trouble is daily data about the date the data was acquired and the degree of dirt. In addition, the degree of dirt is a dirt level and a dirtiness (%).

An optical unit with dirt level 3 is displayed as the trouble that needs to be checked in the cross-sectional view 401 and the trouble detection 404 shown in FIG. 4. An optical unit with a dirt level of 2 is displayed as the trouble that is recommended to be checked in the cross-sectional view 401 and the trouble detection 404 shown in FIG. 4. Record data of the troubles of the optical unit is used to display the dirtiness change graph 611 shown in FIG. 9. In addition, since the record data for each trouble has the display periods of 30 days and 180 days, data for at least 180 days is stored.

Record data of cassette troubles is daily data on the date the data was acquired and the presence or absence of abnormality detection. A cassette with the abnormality detection of “Detected” is displayed as the trouble that needs to be checked in the cross-sectional view 401 and the trouble detection 404 shown in FIG. 4. Each trouble and states of each trouble shown in FIG. 19 are all displayed in the order of column 1101 in the trouble list 601 shown in FIG. 8. Also, if pressing of the treated button 603 performed by the serviceman is detected, the dirt level and the dirtiness are updated to the next values depending on the treated trouble. If the treated trouble is dirt on the optical unit, the dirt level will be level 0, which is an indefinite state, and the data for the dirtiness (%) will be in a state of none. If the treated trouble is in a cassette, the anomaly detection is updated to none. As described above, the trouble record data shown in FIG. 19 is used to display the trouble detection on each screen.

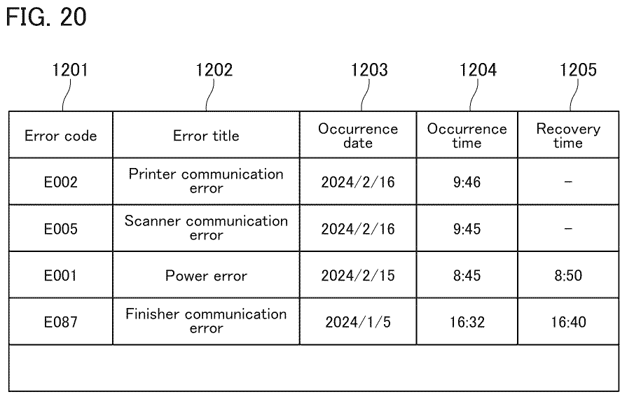

FIG. 20 is a diagram showing an example of error record data. The record data shown in FIG. 20 is used to display information about errors. A column 1201 is a column showing error codes for identifying the errors. A column 1202 is a column showing error titles corresponding to the error codes. A column 1203 is a column showing occurrence dates of the errors. A column 1204 is a column showing occurrence times of the errors. A column 1205 is a column showing recovery times at which the errors have been resolved. Errors with no recovery time recorded in the column 1205 are displayed as occurring errors in the error 404 in FIG. 4. In addition, the record data shown in FIG. 20 is displayed in descending order in the column 1203 and the column 1204 in the error list 701 shown in FIG. 10. Also, although not shown in FIG. 20, the contents corresponding to each error code are stored in the HDD 204 and are displayed on the error details screen shown in FIG. 11. As described above, the record data of the errors shown in FIG. 20 is used to display the errors on each screen.

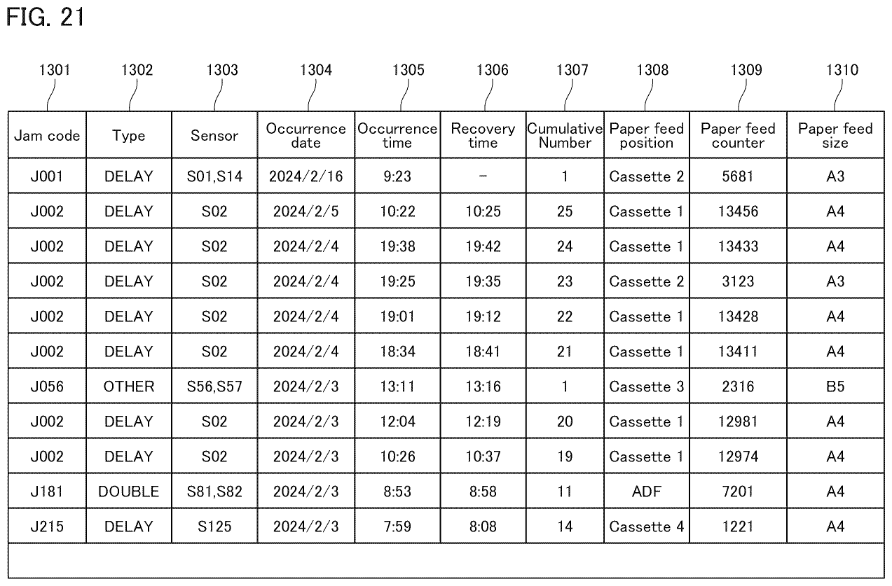

FIG. 21 is a diagram showing an example of jam record data. The jam record data shown in FIG. 21 is used to display jam information. A column 1301 is a column showing jam codes for identifying jams. A column 1302 is a column showing types of the jams corresponding to the jam codes. The jams include various types such as a delay (DELAY), a stay (STNRY), and a double feed (DOUBLE). The delay indicates that paper is not detected by sensors even after an expected time has passed. The stay indicates that paper continues to be detected by sensors even after an expected time has passed. The double feed indicates that a double feed of paper is detected by an automatic document feeder (ADF) sensor.

A column 1303 is a column showing sensor numbers that detected jams. A column 1304 is a column showing occurrence dates of the jams. A column 1305 is a column showing occurrence times of the jams. A column 1306 is a column showing recovery times at which the jams were resolved. Jams with no recovery time recorded in the column 1306 are displayed as occurring jams in the cross-sectional view 401 and the jams 406 shown in FIG. 4. A column 1307 is a column showing cumulative numbers of jams with the same jam codes. The number of jams that have occurred since the reset date and time 804 shown in FIG. 12 is counted up as the cumulative number. If the cumulative number of a jam exceeds a predetermined number of times, for example, 9 times, it is determined to be the frequent jam, and is displayed in the cross-sectional view 401 and the jams 406 shown in FIG. 4.

A column 1308 is a column showing paper feed positions of the paper in which jams have occurred. A column 1309 is a column showing the number of sheets of paper fed from the paper feed positions. A column 1310 is a column showing sizes of the fed paper. The jam record data shown in FIG. 21 is displayed in descending order of the occurrence dates 1304 and the occurrence times 1305 on the jam screen 800 shown in FIG. 12. In this case, as described above, only the latest one of the jams with the same jam code is displayed. Also, the record data of the jams with the same jam code is displayed on the jam details screen 810 shown in FIG. 13. In addition, if the reset button 803 is pressed, the record data of jams before the date and time when the reset button 803 is pressed is deleted. As described above, the jam record data shown in FIG. 21 is used to display the jams on each screen.

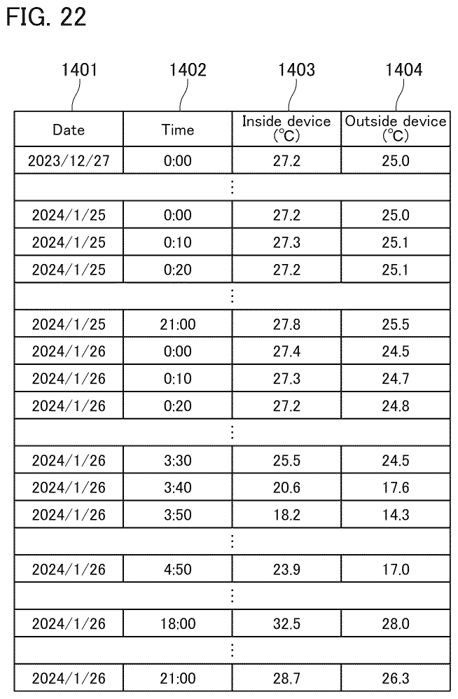

FIG. 22 is a diagram showing an example of usage state record data. The usage state record data shown in FIG. 22 is temperature data used to display the temperature change graph 905 displayed in the temperature change screen shown in FIG. 14.

A column 1401 is a column showing date data indicating the date the temperature data was acquired. The date data for one month is stored and displayed on the date switch button 906 shown in FIG. 14. A column 1402 is a column showing time data indicating the time when the temperature data was acquired. The time data is stored at 10-minute intervals and displayed as the time on the horizontal axis of the temperature change graph 905 shown in FIG. 14.

A column 1403 is a column showing temperature data acquired by a thermometer installed in the device, which is not shown. This temperature data is data showing a temperature inside the device, and is displayed as an internal temperature on the vertical axis of the temperature change graph 905 shown in FIG. 14. A column 1404 is a column showing temperature data acquired by a thermometer installed outside the device, which is not shown. This temperature data is data showing a temperature outside the device, and is displayed as an external temperature on the vertical axis of the temperature change graph 905 shown in FIG. 14.

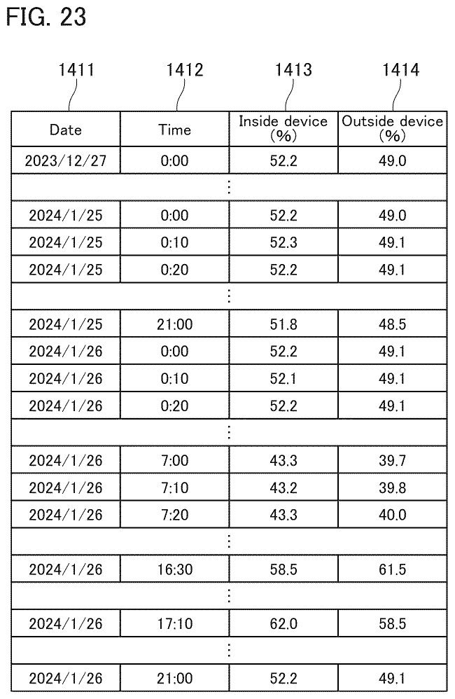

FIG. 23 is a diagram showing an example of usage state record data. The usage state record data shown in FIG. 23 is humidity data used to display the humidity change graph 907 displayed in the humidity change screen shown in FIG. 15.

A column 1411 is a column showing date data indicating the date the humidity data was acquired. The date data for one month is stored and displayed on the date switch button 908 shown in FIG. 15. A column 1412 is a column showing time data indicating the time when the humidity data was acquired. The time data is stored at 10-minute intervals and displayed as the time on the horizontal axis of the temperature change graph 907 shown in FIG. 15.

A column 1413 is a column showing humidity data acquired by a hygrometer installed in the device, which is not shown. This humidity data is data showing a humidity in the device, and is displayed as an internal humidity on the vertical axis of the humidity change graph 907 shown in FIG. 15. A column 1414 is a column showing humidity data acquired by a hygrometer installed outside the device, which is not shown. This humidity data is data showing a humidity outside the device, and is displayed as an external humidity on the vertical axis of the humidity change graph 907 shown in FIG. 15.

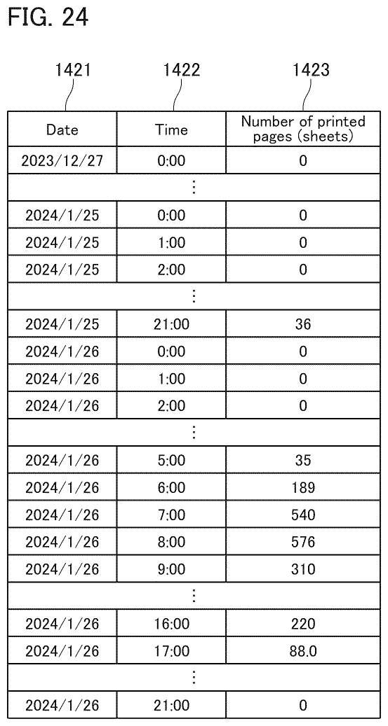

FIG. 24 is a diagram showing an example of usage state record data. The usage state record data shown in FIG. 24 is print count data used to display the print count graph 909 displayed on the print count screen shown in FIG. 16.

A column 1421 is a column showing date data indicating the date when the print count data was acquired. The date data for one month is stored. The date data is used to display the date on the date switch button 908 if “Day” is selected by the display period switch button 910 shown in FIG. 16. Also, the date data is displayed as the date on the horizontal axis of the print count graph 909 if “Month” is selected by the display period switch button 910 shown in FIG. 16.

A column 1422 is a column showing time data indicating the time when the print count data was acquired. The time data is stored at one-hour intervals, and is displayed as the time on the horizontal axis of the print count graph 909 if “Day” is selected by the display period switch button 910 shown in FIG. 16. A column 1423 is a column showing print count data showing the number of sheets printed by the image processing device 103. The print count data is displayed as the number of printed pages on the vertical axis of the print count graph 909 shown in FIG. 16.

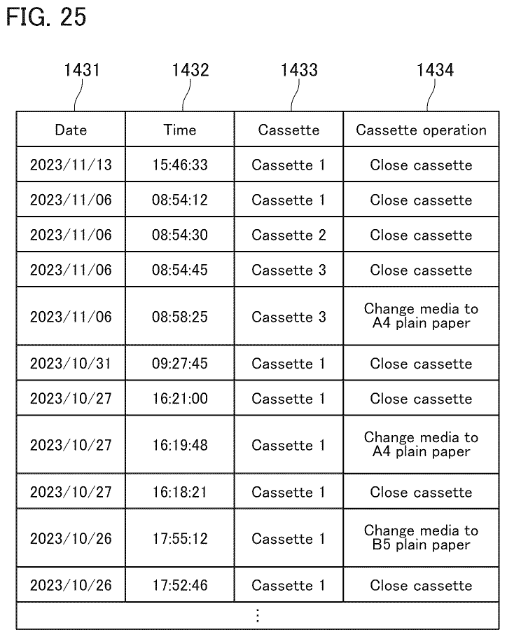

FIG. 25 is a diagram showing an example of usage state record data. The usage state record data shown in FIG. 25 is cassette operation data used to display the cassette record list 912 displayed on the cassette record screen shown in FIG. 17. The cassette operation data is data that is stored when an operation to close a cassette in the image processing device 103 or an operation to change media is performed.

A column 1431 is a column showing date data indicating the date the cassette operation data was acquired. A maximum of 300 pieces of the date data are stored. Also, the date data is displayed in the order shown in the column 1431 in the cassette record list 912 shown in FIG. 17. A column 1432 is a column showing time data indicating the time at which a cassette operation was performed. The time data is data showing the time when an operation was performed on the cassette, and is displayed as the time in the cassette record list 912 shown in FIG. 17.

A column 1433 is a column showing cassette operation data indicating a cassette for which an operation on the cassette was performed. A column 1433 displays “Cassette closed” if the operation to close the target cassette is performed. In addition, the column 1433 displays “Media change” if an operation to change the media is performed for the target cassette. Further, if an operation is performed to change the media for the target cassette, a paper size and a paper type are stored. The cassette operation data is displayed as a record of operations on the cassette in the cassette record list 912 shown in FIG. 17. Also, it is assumed that the column 1433 may indicate not only the cassette operation data, but also manual feed operation data indicating that a manual feed operation was performed.

### <Featured Processes of First Embodiment>

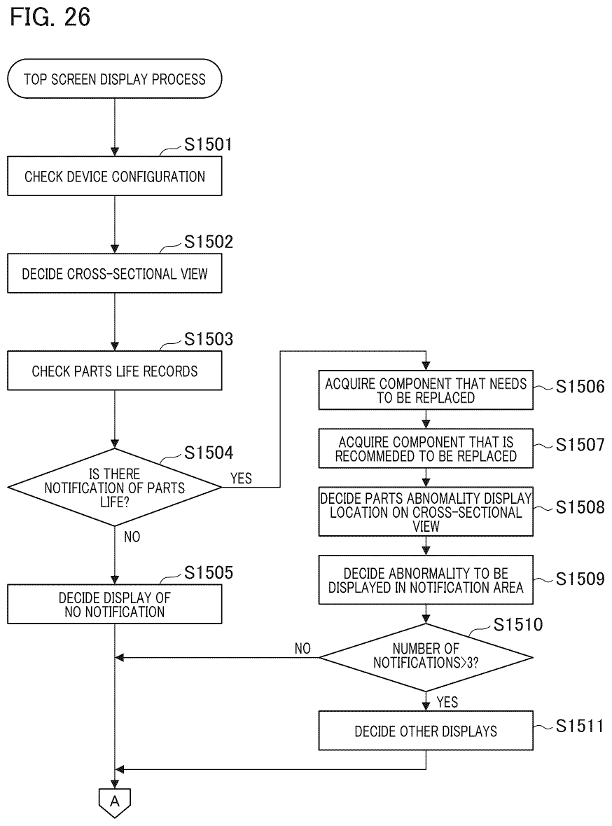

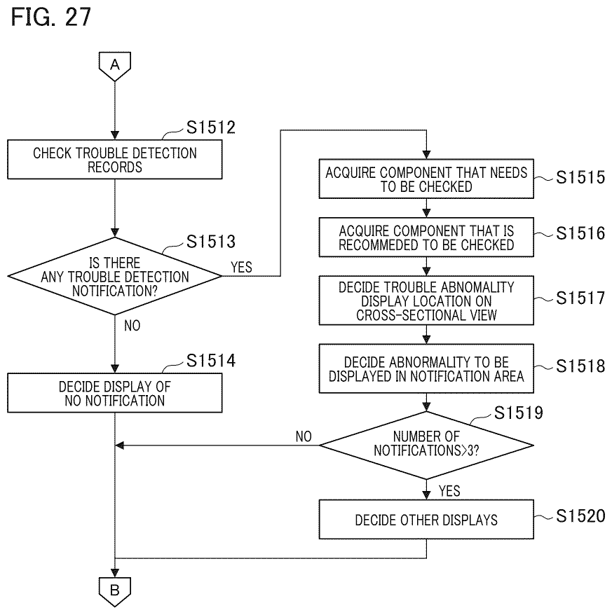

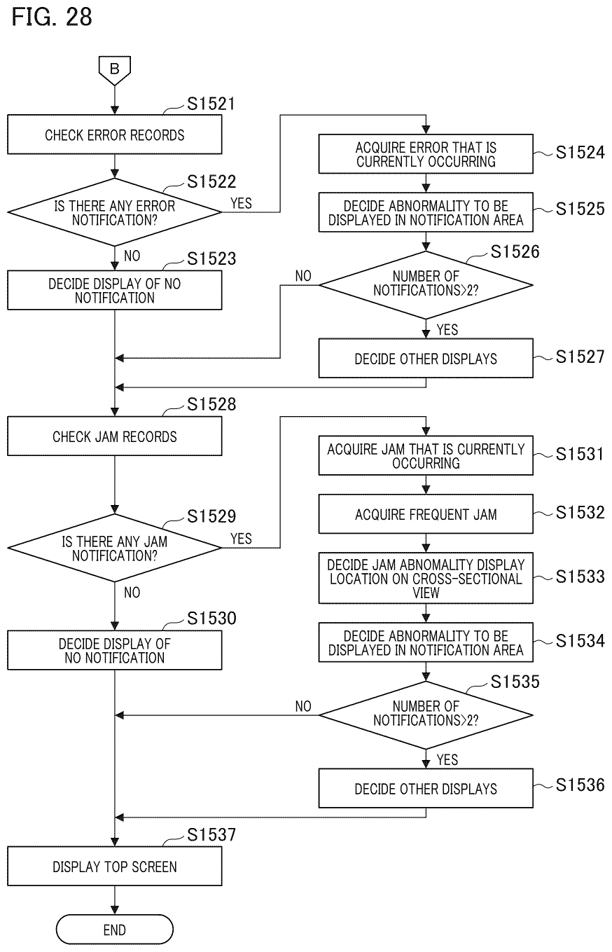

FIGS. 26 to 28 are flowcharts showing an example of a startup of the state monitor top screen. Firmware relating to processes in the flowcharts shown in FIGS. 26 to 28 is stored in the HDD 204 of the image processing device 103, loaded by the RAM 202, and executed by the CPU 201. This process is started on the basis of reception of a special command input from the operation unit 212 to start the state monitor.

In step S1501, the CPU 201 refers to device configuration information of the image processing device 103 stored in the RAM 202. Also, the device configuration information is not shown.

In step S1502, the CPU 201 decides the cross-sectional view to be displayed on each screen. The CPU 201 changes the cross-sectional view to be displayed depending on, for example, the presence or absence of a scanner, the presence or absence of a paper feed option, and the presence or absence of a paper discharge option. Also, if a program is common to a plurality of devices, the CPU 201 may switch to the cross-sectional view suitable for each model in accordance with the device configuration information. This is because the paper transport path, and the positions of each part and jam sensor vary depending on the model of the image processing device 103.

In step S1503, the CPU 201 refers to the parts life record data stored in the HDD 204 and shown in FIG. 18.

In step S1504, the CPU 201 determines whether or not there are any parts with a state level of 2 or higher as a result of the reference in step S1503. If the CPU 201 determines that there are any parts with a state level of 2 or higher as a result of the reference in step S1503 (step S1504: YES), the process proceeds to step S1506. On the other hand, if the CPU 201 determines that there were no parts with a state level of 2 or higher as a result of the reference in step S1503 (step S1504: NO), the process proceeds to step S1505.

In step S1505, since there is no parts life icon to be displayed in the cross-sectional view 401 shown in FIG. 4, the CPU 201 decides to display “No notification” in the notification area of the parts life 403.

In step S1506, the CPU 201 acquires information about components whose state level is 3 and which need to be replaced from the parts life record data in the HDD 204.

In step S1507, the CPU 201 acquires information about components whose state level is 2 and which are recommended to be replaced from the parts life record data in the HDD 204.

In step S1508, the CPU 201 decides the locations for displaying the icons regarding the information about the components acquired in step S1506 and the locations for displaying the icons regarding the information about the components acquired in step S1507.

In step S1509, the CPU 201 decides the abnormality to be displayed in the notification area. Then, in step S1509, the CPU 201 displays the components for which the information was acquired in step S1506 and the components for which the information was acquired in step S1507 in order of priority. A priority of a component whose state level is 3 and which needs to be replaced is higher than a priority of a component whose state level is 2 and which is recommended to be replaced. Also, if there are a plurality of components with the same state level, the CPU 201 displays them in the order shown in FIG. 18.

Also, in this case, in step S1510, the CPU 201 determines whether or not the number of components to be notified is greater than the number of components that can be displayed in a display area of the parts life 403. The number of components that can be displayed in the display area of the parts life 403 is, for example, 3. If the number of components to be notified is equal to or less than the number of components that can be displayed in the display area of the parts life 403 (step S1510: NO), the CPU 201 advances the process to step S1512. On the other hand, if it is determined that the number of components to be notified is greater than the number of components that can be displayed in the display area of the part life 403 (step S1510: YES), the CPU 201 advances the process to step S1511.

In step S1511, the CPU 201 displays the notifications that cannot be displayed with the text “Other:” and the number of notifications.

In step S1512, the CPU 201 refers to the trouble detection record data stored in the HDD 204 and shown in FIG. 19.

In step S1513, the CPU 201 determines whether or not there is a trouble with a dirt level of 2 or higher in the optical unit or cassette abnormality as a result of the reference in step S1512. If it is determined that there is no trouble with a dirt level of 2 or higher in the optical unit or cassette abnormality as a result of the reference in step S1512 (step S1513: NO), the CPU 201 advances the process to step S1514. On the other hand, if it is determined that there is a trouble with a dirt level of 2 or higher in the optical unit or cassette abnormality as a result of the reference in step S1512 (step S1513: YES), the CPU 201 advances the process to step S1515.

In step S1514, since there is no trouble detection icon to be displayed in the cross-sectional view 401 shown in FIG. 4, the CPU 201 decides to display “No notification” in the notification area of the trouble detection 404.

In step S1515, the CPU 201 acquires information about troubles that needs to be checked. For example, the CPU 201 acquires information about optical units with a dirt level of 3 and cassettes with abnormalities from the trouble detection record data in the HDD 204.

In step S1516, the CPU 201 acquires information about troubles that are recommended to be checked. For example, the CPU 201 acquires information about optical units with a state level of 2 from the trouble detection record data in the HDD 204.

In step S1517, the CPU 201 decides the locations for displaying the icons regarding the information about the troubles acquired in step S1515 and the locations for displaying the icons regarding the information about the troubles acquired in step S1516.

In step S1518, the CPU 201 decides the abnormality to be displayed in the notification areas. Then, in step S1518, the CPU 201 displays the troubles for which the information was acquired in step S1515 and the troubles for which the information was acquired in step S1516 in order of priority. A priority of a trouble whose dirt level is 3 and which needs to be checked is higher than a priority of a trouble whose dirt level is 2 and which is recommended to be checked. Also, if there are a plurality of troubles with the same dirt level, the CPU 201 displays them in the order shown in FIG. 19.

Also, in this case, in step S1519, the CPU 201 determines whether or not the number of troubles to be notified is greater than the number of troubles that can be displayed in the display area of the trouble detection 404. The number of troubles that can be displayed in the display area of the trouble detection 404 is, for example, 3. If the number of troubles to be notified is equal to or less than the number of troubles that can be displayed in the display area of the trouble detection 404 (step S1519: NO), the CPU 201 advances the process to step S1521. On the other hand, if the number of troubles to be notified is greater than the number of troubles that can be displayed in the display area of the trouble detection 404 (step S1519: YES), the CPU 201 advances the process to step S1520.

In step S1520, the CPU 201 displays the notifications that cannot be displayed with the text “Other:” and the number of notifications.

In step S1521, the CPU 201 refers to the error record data stored in the HDD 204 and shown in FIG. 20.

In step S1522, as a result of the reference in step S1521, the CPU 201 determines whether or not there is a currently occurring error whose recovery time is not registered in the error record data shown in FIG. 20. If it is determined that there is no currently occurring error whose recovery time is not registered (step S1522: NO), the CPU 201 advances the process to step S1523. On the other hand, if it is determined that there is a currently occurring error whose recovery time is not registered (step S1522: YES), the CPU 201 advances the process to step S1524.

In step S1523, the CPU 201 decides to display “No notification” in the notification area of the errors 405.

In step S1524, the CPU 201 acquires information regarding a currently occurring error whose recovery time is not registered in the error record data shown in FIG. 20 from the error record data in the HDD 204.

In step S1525, the CPU 201 decides the anomality to be displayed in the notification area. Then, in step S1525, the CPU 201 displays the errors required for the information acquired in step S1524 in descending order of acquisition.

Also, in this case, in step S1526, the CPU 201 determines whether or not the number of errors to be notified is greater than the number of errors that can be displayed in the display area of the errors 405. The number of notifications that can be displayed in the display area of the errors 405 is, for example, 2. If it is determined that the number of errors to be notified is equal to or less than the number of errors that can be displayed in the display area of the errors 405 (step S1526: NO), the CPU 201 advances the process to step S1528. On the other hand, if it is determined that the number of errors to be notified is greater than the number of errors that can be displayed in the display area of the errors 405 (step S1526: YES), the CPU 201 advances the process to step S1527.

In step S1527, the CPU 201 displays the notifications that cannot be displayed with the text “Other:” and the number of notifications.

In step S1528, the CPU 201 refers to the jam record data stored in the HDD 204 and shown in FIG. 21.

In step S1529, as a result of the reference in step S1528, the CPU 201 determines whether or not there is a currently occurring jam whose jam recovery time shown in FIG. 21 is not registered or a frequent jam whose cumulative number shown in FIG. 21 is 10 or more. If it is determined that there is no currently occurring jam whose jam recovery time shown in FIG. 21 is not registered or no frequent jam whose cumulative number shown in FIG. 21 is 10 or more (step S1529: NO), the CPU 201 advances the process to step S1530. On the other hand, if it is determined that there is a currently occurring jam whose jam recovery time shown in FIG. 21 is not registered or a frequent jam whose cumulative number shown in FIG. 21 is 10 or more (step S1529: YES), the CPU 201 advances the process to step S1531.

In step S1530, since there is no jam icon to be displayed in the cross-sectional view 401 shown in FIG. 4, the CPU 201 decides to display “No notification” in the notification area of the jams 406.

In step S1531, the CPU 201 acquires information regarding an occurring jam whose recovery time is not registered in the jam record data shown in FIG. 21 from the jam record data in the HDD 204.

In step S1532, the CPU 201 acquires information about a frequent jam whose cumulative number is 10 or more registered in the jam record data shown in FIG. 21 from the jam record data in the HDD 204. Also, in step S1532, if a plurality of pieces of data with the same jam code are registered in the jam record data shown in FIG. 21, the CPU 201 acquires information about the latest one of jams.

In step S1533, the CPU 201 decides the location at which the abnormality is to be displayed in the cross-sectional view 401 shown in FIG. 4. Then, in step S1533, the CPU 201 displays icons for the jam about which the information was acquired in step S1531 and for the jam about which the information was acquired in step S1532 at the coordinates of the relevant locations.

In step S1534, the CPU 201 decides the abnormality to be displayed in the notification area. Then, in step S1534, CPU 201 displays the jams about which the information was acquired in step S1531 and the jams about which the information was acquired in step S1532 in order of priority. A priority of a currently occurring is higher than a frequent jam. Also, if there are a plurality of jams with the same priority, the CPU 201 displays them in descending order of the order in which the information was acquired. Further, for jams that fall under both currently occurring jams and frequent jams, the CPU 201 gives priority to displaying the icon for the currently occurring jam.

In this case, in step S1535, the CPU 201 determines whether or not the number of jams to be notified is greater than the number of jams that can be displayed in the display area of the jams 406. The number of jams that can be displayed in the display area of the jams 406 is, for example, 2. If it is determined that the number of jams to be notified is equal to or less than the number of jams that can be displayed in the display area of the jams 406 (step S1535: NO), the CPU 201 advances the process to step S1537. On the other hand, if it is determined that the number of jams to be notified is greater than the number of jams that can be displayed in the display area of the jams 406 (step S1535: YES), the CPU 201 advances the process to step S1536.

In step S1536, the CPU 201 displays the notifications that cannot be displayed with the text “Other:” and the number of notifications.

In step S1537, the CPU 201 displays the display contents decided in steps S1501 to S1536 on the screen of the operation unit 212. That is, in step S1537, the CPU 201 displays the top screen 400 of the state monitor shown in FIG. 4. Through the process shown in FIGS. 26 to 28, the CPU 201 can display any abnormalities in the image processing device 103 that an on-site serviceman wishes to check urgently and their locations with the cross-sectional view 401 and the notifications.

Accordingly, the CPU 201 can inform the serviceman of the overview of abnormal locations of the image processing device 103 on a single screen of the top screen 400. Also, due to this, the CPU 201 can improve the efficiency of the work of checking the abnormal locations performed by the serviceman who is required to respond quickly on-site. Further, due to this, the CPU 201 can allow the serviceman to identify locations at which abnormalities are concentrated from the cross-sectional view 401 shown in FIG. 4 and to consider efficient work procedures, such as working on the locations at which abnormalities are concentrated together.

In addition, due to this, the CPU 201 can allow the serviceman to read a correlation between occurrences of the respective abnormalities from a positional relationship between the abnormality occurrence locations shown in the cross-sectional view 401. For example, if the notification that the cassette roller 1 needs to be replaced and the notification that jams are occurring frequently near the cassette roller 1 are issued simultaneously, the CPU 201 can allow the serviceman to recognize the following. That is, in such a case, the CPU 201 can allow the serviceman to recognize that there is a high possibility of resolving the frequent jams by replacing the cassette roller 1.

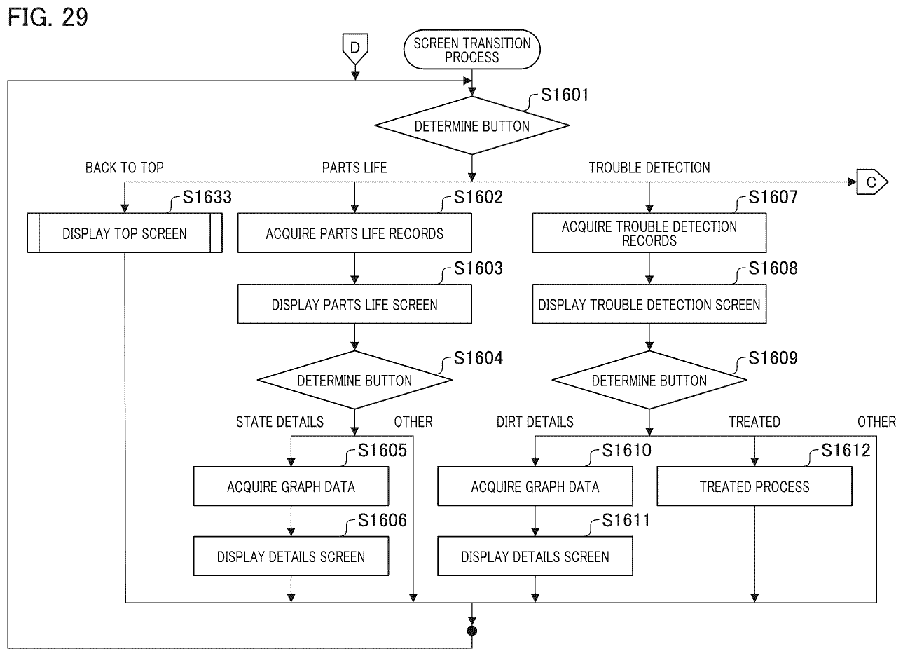

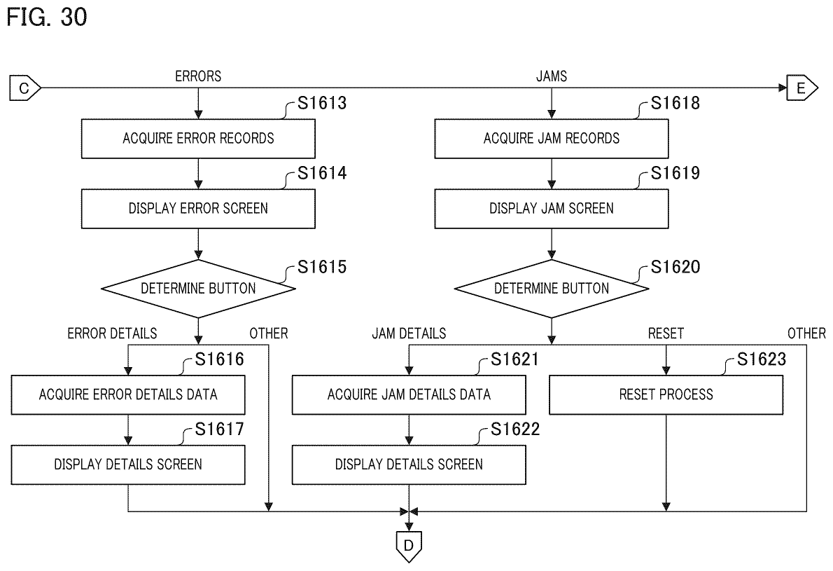

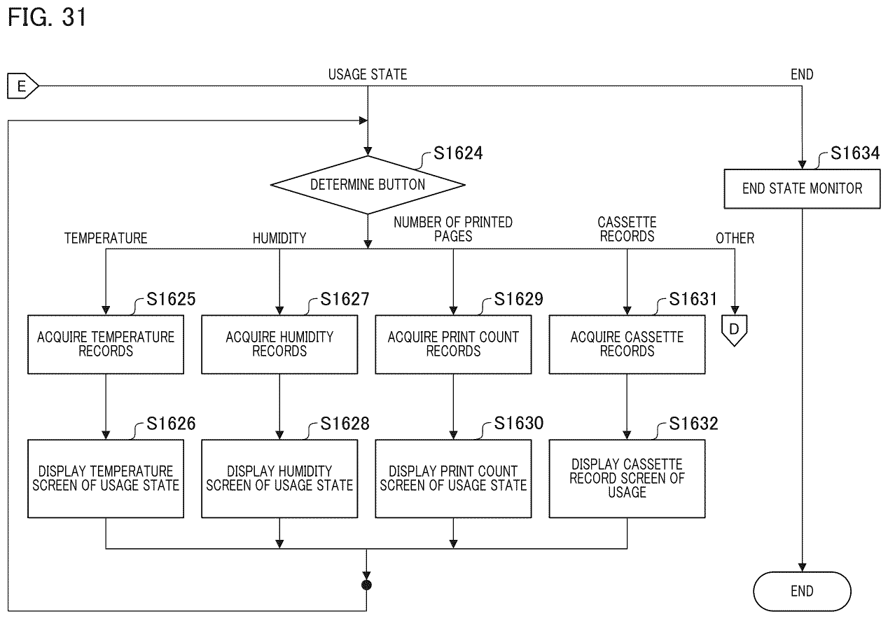

Next, with reference to FIGS. 29 to 31, an example of a screen transition process in response to an operation to switch between the respective screens shown in FIGS. 4 to 17 will be described. FIGS. 29 to 31 are flowcharts showing an example of screen transition to the state monitor top screen and each details screen. The processes shown in FIGS. 29 to 31 are started on the basis of reception of an input from the operation unit 212 while one of the respective screens shown in FIGS. 4 to 17 is displayed on the operation unit 212.

In step S1601, if it is detected that a button on the screen has been pressed, the CPU 201 determines which of the buttons shown in FIGS. 4 to 17 has been pressed. First, a case in which the pressed button is the parts life 403 or the parts life button 502 will be described. In step S1601, if the parts life 403 or the parts life button 502 is pressed, the CPU 201 sets the determination result to “Parts life” and advances the process to step S1602.

Also, in step S1601, if it is determined that the back to top Screen button 501 has been pressed, the CPU 201 advances the process to step S1633. In step S1601, if it is determined that the error button 504 has been pressed, the CPU 201 advances the process to step S1613. In step S1601, if it is determined that the jam button 505 has been pressed, the CPU 201 advances the process to step S1618.

In step S1602, the CPU 201 acquires the parts life record data stored in the HDD 204 and shown in FIG. 18.

In step S1603, the CPU 201 displays the parts life screen 500 shown in FIG. 6 on the operation unit 212 in accordance with the parts life record data acquired in step S1602. In this case, only the abnormal locations relating to the parts life decided in step S1508 of the flowchart shown in FIGS. 26 to 28 are displayed in the cross-sectional view 401. Also, the parts list 507 displays the states of all the parts listed in the parts life record data shown in FIG. 18.

In step S1604, the CPU 201 determines which button on the parts life screen 500 has been pressed. In step S1604, if it is determined that the state details button 508 has been pressed, the CPU 201 sets the determination result as “State details” and advances the process to step S1605.

In step S1605, the CPU 201 acquires graph data. Specifically, in step S1605, the CPU 201 refers to the record data 1003 of the states of the component selected in the parts list 507 from the parts life record data stored in the HDD 204 and shown in FIG. 18.

In step S1606, the CPU 201 creates a graph of the state values (%) and displays the state details screen 510 shown in FIG. 7 in accordance with the time series of the dates in the state record data referenced in step S1605. In this case, the CPU 201 displays the data for the display period specified by display period 512 in the state change graph 511. Also, although not shown in FIGS. 29 to 31, if the close button 513 is pressed after the state details screen 510 is displayed, the screen returns to the parts life screen 500. Then, the screen returns to waiting for input in step S1601.

In step S1604, if it is determined that the state details button 508 has been pressed, the CPU 201 sets the determination result as “State details” and advances the process to step S1605.

In step S1604, if it is determined that a button other than the state details button 508 has been pressed, the CPU 201 sets the determination result to “Other” and advances the process to step S1601. Then, in step S1601, the CPU 201 determines whether or not any of the back to top screen button 501, the parts life button 502, the trouble detection button 503, the error button 504, the jam button 505, and the usage state button 506 has been pressed.

Next, a case in which the CPU 201 determines in step S1601 that the trouble detection 404 or the trouble detection button 503 has been pressed will be described.

In step S1601, if it is determined that the trouble detection 404 or the trouble detection button 503 has been pressed, the CPU 201 sets the determination result as “Trouble detection” and advances the process to step S1607.

In step S1607, the CPU 201 acquires the trouble detection record data stored in the HDD 204 and shown in FIG. 19.

In step S1608, the CPU 201 displays the trouble detection screen 600 shown in FIG. 8 on the operation unit 212 in accordance with the trouble detection record data acquired in step S1607. In this case, only the abnormal locations relating to the trouble detection decided in step S1517 are displayed in the cross-sectional view 401. Also, the trouble list 601 also displays the states of all troubles listed in the trouble detection record data shown in FIG. 19.

In step S1609, if it is detected that a button on the screen has been pressed, the CPU 201 determines which button on the trouble detection screen 600 has been pressed. If it is determined that the pressed button is the dirt details button 602, the CPU 201 sets the determination result in step S1609 as “Dirt details” and advances the process to step S1610.

In step S1610, the CPU 201 acquires graph data. Specifically, in step S1610, the CPU 201 refers to the trouble record data 1103 of the optical unit selected in the trouble list 601 from the trouble detection record data stored in the HDD 204 and shown in FIG. 19.

In step S1611, the CPU 201 creates a graph of the dirtiness (%) and displays the dirt details screen 610 shown in FIG. 9 in accordance with the time series of the dates in the trouble record data referenced in step S1610. In this case, the CPU 201 displays the data for the display period specified in the display period 612 in the dirt change graph 611. Also, although not shown in FIGS. 29 to 31, if the close button 613 is pressed after the dirt details screen 610 is displayed, the screen returns to the trouble detection screen 600. Then, the screen returns to waiting for input in step S1601.

In step S1609, the CPU 201 determines which button on the trouble detection screen 600 has been pressed. In step S1609, if it is determined that the treated button 603 has been pressed, the CPU 201 sets the determination result as “Treated” and advances the process to step S1612.

In step S1612, the CPU 201 executes the treated process for the trouble selected in the trouble list 601. For example, if the trouble selected in the trouble list 601 is an optical unit, the CPU 201 executes a process to reset the dirt level of the trouble record data shown in FIG. 19 to the initial value of 0. Also, for example, if the trouble selected in the trouble list 601 is a cassette, the CPU 201 executes a process to reset the abnormality detection of the trouble record data shown in FIG. 19 to the initial value of none. Then, the CPU 201 displays the trouble detection screen 600 of FIG. 19 reflecting the latest trouble detection record data.

In step S1609, if the pressed button is other than the dirt details button 602 and the treated button 603, the CPU 201 sets the determination result of step S1609 to “Other.” Then, the CPU 201 advances the process to the determination of step S1601. In step S1601, the CPU 201 determines which button has been pressed among the back to top screen button 501, the parts life button 502, the trouble detection button 503, the error button 504, the jam button 505, and the usage state button 506.

Next, a case in which the CPU 201 determines in step S1601 that errors 405 or the error button 504 has been pressed will be described.

In step S1601, if it is determined that the errors 405 or the error button 504 has been pressed, the CPU 201 sets the determination result as “Error” and advances the process to step S1613.

In step S1613, the CPU 201 acquires the error record data stored in the HDD 204 and shown in FIG. 20.

In step S1614, the CPU 201 displays the error screen 700 shown in FIG. 10 on the operation unit 212 in accordance with the error record data acquired in step S1613. In this case, the error list 701 displays all errors listed in the error record data shown in FIG. 20.

In step S1615, the CPU 201 determines which button on the error screen 700 has been pressed. If it is determined in step S1615 that the error details button 702 has been pressed, the CPU 201 sets the determination result to “Error details” and advances the process to step S1616.

In step S1616, the CPU 201 acquires error details data. Specifically, in step S1616, the CPU 201 refers to detailed information registered in the HDD 204, which is not shown, regarding the error code selected in the error list 701.

In step S1617, the CPU 201 displays the error details screen 710 shown in FIG. 11 using the error information referenced in step S1616. Also, although not shown in FIGS. 29 to 31, if the close button 714 is pressed after the error details screen 710 is displayed, the screen returns to the error screen 700. Then, the screen returns to waiting for input in step S1601.

In step S1615, if it is determined that a button other than the error details button 702 has been pressed, the CPU 201 sets the determination result as “Other” and advances the process to step S1601. Then, in step S1601, the CPU 201 determines whether or not any of the back to top screen button 501, the parts life button 502, the trouble detection button 503, the error button 504, the jam button 505, and the usage state button 506 has been pressed.

Next, a case in which the CPU 201 determines in step S1601 that the jams 406 or the jam button 505 has been pressed will be described.

In step S1601, if it is determined that the jams 406 or the jam button 505 has been pressed, the CPU 201 sets the determination result as “Jam” and advances the process to step S1618.

In step S1618, the CPU 201 acquires the jam record data stored in the HDD 204 and shown in FIG. 21.

In step S1619, the CPU 201 displays the jam screen 800 shown in FIG. 12 on the operation unit 212 in accordance with the jam record data acquired in step S1618. In this case, only the abnormal locations relating to the jam decided in step S1533 are displayed in the cross-sectional view 401. Also, the jam list 801 displays only the latest data for each jam code from the jam record data shown in FIG. 21. In addition, in step S1619, if a plurality of pieces of data with the same jam code are registered in the jam record data shown in FIG. 21, the CPU 201 displays information about the latest one of the jams.

In step S1620, the CPU 201 determines which button on the jam screen 800 has been pressed. In step S1620, if it is determined that the jam details button 802 has been pressed, the CPU 201 sets the determination result as “Jam details” and advances the process to step S1621.

In step S1621, the CPU 201 acquires the jam details data that is stored in the HDD 204 and matches the jam code of the jam selected in the trouble list 601 from the record data shown in FIG. 21.

In step S1622, the CPU 201 displays the jam details screen 810 shown in FIG. 13 using the jam details data that matches the jam code acquired in step S1621. Also, although not shown in FIGS. 29 to 31, if the close button 814 is pressed after the jam details screen 810 is displayed, the screen returns to the jam screen 800. Then, the screen returns to waiting for input in step S1601.

In step S1620, if it is determined that the reset button 803 has been pressed, the CPU 201 sets the determination result as “Reset” and advances the process to step S1623.

In step S1623, the CPU 201 deletes the jam record data shown in FIG. 21 and updates the date and time of the reset date and time 804 to the date and time the reset button was pressed. Then, the CPU 201 displays the jam screen 800 shown in FIG. 21, which reflects the latest jam record data.

In step S1620, if it is determined that a button other than the jam details button 802 or the reset button 803 has been pressed, the CPU 201 sets the determination result as “Other” and advances the process to step S1601. Then, in step S1601, the CPU 201 determines whether or not any of the back to top screen button 501, the parts life button 502, the trouble detection button 503, the error button 504, the jam button 505, and the usage state button 506 has been pressed.

Next, a case in which the CPU 201 determines in step S1601 that the usage state 407 or the usage state button 506 has been pressed will be described.

In step S1601, if it is determined that the usage state 407 or the usage status button 506 has been pressed,, the CPU 201 sets the determination result as “Usage state” and advances the process to step S1624.

In step S1624, the CPU 201 determines which button on the usage state screen 900 has been pressed. A default value of the usage state screen 900 is selection of the temperature button 901, and thus If the transition has been made from a screen other than the usage state screen 900, the CPU 201 sets the determination result as “Temperature” in step S1624 and advances the process to step S1625.

In step S1625, the CPU 201 acquires the temperature data stored in the HDD 204 and shown in FIG. 22.

In step S1626, the CPU 201 creates a temperature change graph of the data inside the device and a temperature change graph of the data outside of the device in accordance with the time series of the date data and the time data from the temperature data acquired in step S1625. Then, the CPU 201 displays the usage state screen 900 shown in FIG. 14 on the operation panel 212. Then, the screen returns to waiting for input in step S1624.

In step S1624, if it is determined that the humidity button 902 has been pressed, the CPU 201 sets the determination result as “Humidity” and advances the process to step S1627.

In step S1627, the CPU 201 acquires the humidity data stored in the HDD 204 and shown in FIG. 23.

In step S1628, the CPU 201 creates a humidity change graph of the data inside the device and a humidity change graph of the data outside the device in accordance with the time series of the date data and the time data from the humidity data acquired in step S1627. Then, the CPU 201 displays the humidity change screen shown in FIG. 15 on the operation unit 212. Then, the screen returns to waiting for input in step S1624.

In step S1624, if it is determined that the print count button 903 has been pressed, the CPU 201 sets the determination result as “Number of printed pages” and advances the process to step S1629.

In step S1629, the CPU 201 acquires the print count data stored in the HDD 204 and shown in FIG. 24.

In step S1630, the CPU 201 creates a print count graph of the print count data in accordance with the time series of the date data and the time data from the print count data acquired in step S1629. In addition, if “Day” is selected by the display period switch button 910 shown in FIG. 16, the CPU 201 creates a graph of the print count data for each hour for one day. Also, if “Month” is selected by the display period switch button 910 shown in FIG. 16, the CPU 201 creates a graph of the print count data for each day for one month. Then, the CPU 201 displays the print count screen shown in FIG. 16 on the operation unit 212. Then, the screen returns to waiting for input in step S1624.

In step S1624, if it is determined that the cassette record button 904 has been pressed, the CPU 201 sets the determination result as “Cassette record” and advances the process to step S1631.

In step S1631, the CPU 201 acquires the cassette operation data stored in the HDD 204 and shown in FIG. 25.

In step S1632, the CPU 201 creates a cassette record list of the cassette operation data in accordance with the time-series order of the date data and the time data from the cassette operation data acquired in step S1631. Also, the CPU 201 creates the cassette record list 912 by extracting only the data for the cassette selected by the cassette switch button 913 shown in FIG. 17. For example, in the example shown in FIG. 17, “Cassette 1” is selected by the cassette switch button 913. For this reason, the CPU 201 extracts data Nos. 1, 2, 6, 7, 8, 9, 10, and 11 indicating “Cassette 1” from the column 1433 shown in FIG. 25, and creates the cassette record list 912. Then, the CPU 201 displays the cassette record screen shown in FIG. 17 on the operation unit 212. Then, the screen returns to waiting for input in step S1624.

In step S1624, if it is determined that a button other than the temperature button 901, the humidity button 902, the print count button 903, and the cassette record button 904 has been pressed, the CPU 201 sets the determination result as “Other” and advances the process to step S1601. Then, in step S1601, the CPU 201 determines whether or not any of the back to top screen button 501, the parts life button 502, the trouble detection button 503, the error button 504, the jam button 505, and the usage state button 506 has been pressed.

Also, each screen shown in FIGS. 6 to 17 displays the back to top button 501, and thus if it is determined that the back to top button 501 has been pressed, the CPU 201 sets the determination result as “Back to top” and advances the process to step S1633.

In step S1633, CPU 201 executes the process of displaying the top screen shown in FIGS. 26 to 28, and displays the top screen 400.

Next, a case in which an operation to end the state monitor (not shown) is input on each screen shown in FIG. 4 to FIG. 17 will be described.

In step S1601, if an operation to end the state monitor is detected, the CPU 201 sets the determination result as “End.” Then, in step S1634, the CPU 201 executes a process to end the display of the state monitor.

As described above, the flowcharts shown in FIGS. 29 to 31 show that the serviceman can transition from the top screen 400 shown in FIG. 4 to each screen in order to check detailed information. Each screen referred to here is the parts life screen 500, the trouble detection screen 600, the error screen 700, the jam screen 800, and the usage status screen 900 shown in FIGS. 6 to 17. Thus, the serviceman can quickly display each details screen from the top screen 400 and gather information required for treatment.

Also, as described above, it is possible to switch between each detail screen using the part life button 502, the trouble detection button 503, the error button 504, the jam button 505, and the usage state button 506. For this reason, the serviceman can infer the cause of the abnormality from the information relating to each details screen and to consider countermeasures based on that inference. In addition, for this reason, the serviceman can infer a timing when an abnormality will occur at a location at which no abnormality is currently occurring, and make preparations based on that inference. Further, the timing is inferred mainly on the basis of the parts life and the degree of dirt on the optical unit.

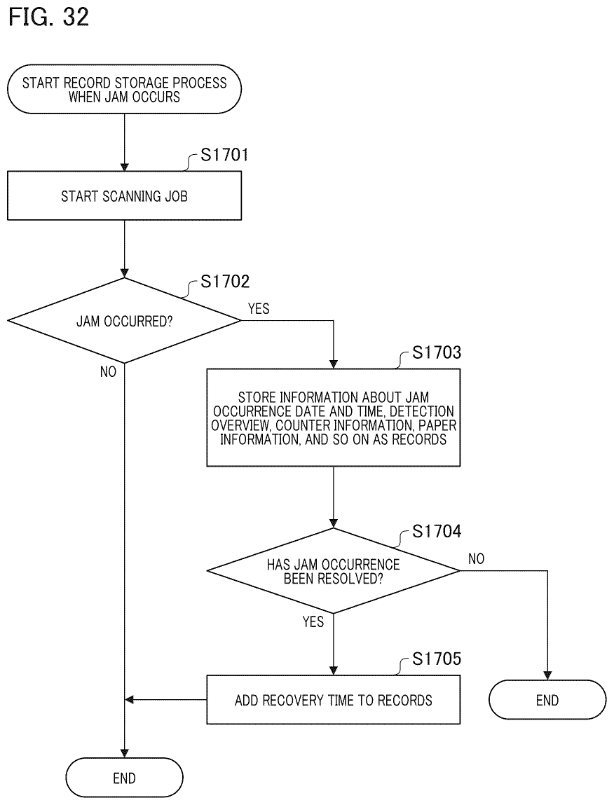

Next, a process of storing a jam occurrence record will be described with reference to FIGS. 21 and 32. FIG. 32 is a flow chart for describing the process of storing the jam occurrence record. Each of the steps shown in FIG. 32 is executed by the CPU 201 of the image processing device 103 executing the program.

In step S1701, the CPU 201 executes a job. In the first embodiment, it is assumed that a scan job is executed in step S1701, but other jobs such as a copy job may also be executed.

In step S1702, the CPU 201 determines whether or not a jam has occurred on the basis of the various sensors 255. If it is determined that a jam has occurred (step S1702: YES), the CPU 201 advances the process to step S1703. On the other hand, if it is determined that a jam has not occurred (step S1702: NO), the CPU 201 ends the process.

In step S1703, the CPU 201 uses the record management unit 304 to store information when the jams have occurred as the record. In the first embodiment, counter information indicating the dates and times the jams have occurred, the positions of the sensors that detected the jams, and the total number of sheets of paper that have been read is stored, but the information is not limited to such information as long as it is information required for dealing with the jams. For example, instead of information indicating the positions of the sensors that detected the jams, information indicating the positions at which the jams have occurred may be stored.

In step S1704, the CPU 201 determines whether or not the jam that has occurred has been resolved. If it is determined that the jam that has occurred has been resolved (step S1705: YES), the CPU 201 advances the process to step S1705. On the other hand, if it is determined that the jam that has occurred has not been resolved (step S1704: NO), the CPU 201 ends the process.

In step S1705, the CPU 201 uses the record management unit 304 to add the recovery time to the jam occurrence record. The recovery time added here is, for example, the recovery time shown in column 1306 in FIG. 21.

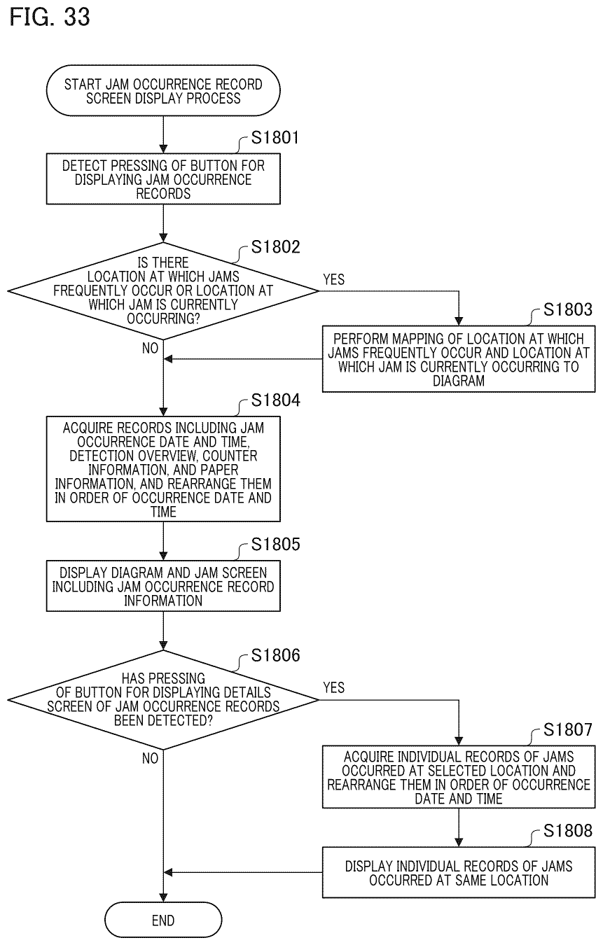

Next, a process of displaying the jam screen 800 will be described with reference to FIGS. 12, 13, and 33. FIG. 33 is a flowchart for describing the process of displaying the jam screen 800 and the jam details screen 810.

In step S1801, the CPU 201 detects whether the button for displaying the jam occurrence record has been pressed using the operation unit 212. In the first embodiment, a scene is assumed in which the CPU 201 detects whether the jam 406 shown in FIG. 4 or FIG. 5, or the jam button 505 shown in FIG. 6 has been pressed. Also, in step S1901, it is assumed that the button is pressed by the serviceman, but the button may be pressed by the user.

In step S1802, the CPU 201 uses the control unit 301 to determine whether the location at which a jam is currently occurring or the location at which jams frequently occur is in the jam occurrence record stored in the record management unit 304. In the first embodiment, a location at which jams have occurred three or more times is assumed to be the location at which jams frequently occur, but a location at which jams have occurred more than a number specified by the user may be assumed to be the location at which jams frequently occur. Also, the location at which a jam is currently occurring indicates a location at which the above-described recovery time is not stored. In addition, for the occurrence record of the jam whose recovery time is stored by the process of step S1705, the jam is considered to have been resolved.

If it is determined that the location at which a jam is currently occurring or the location at which jams frequently occur is in the jam occurrence record stored in the record management unit 304 (step S1802: YES), the CPU 201 advances the process to step S1803. On the other hand, if it is determined that the location at which a jam is currently occurring or the location at which jams frequently occur is not in the jam occurrence record stored in the record management unit 304 (step S1802: NO), the CPU 201 advances the process to step S1804.

In step S1803, the CPU 201 performs mapping of icons indicating the location at which a jam is currently occurring or the location at which jams frequently occur to the cross-sectional view 401 of the image processing device 103.

In step S1804, the CPU 201 acquires the jam occurrence record stored in the record management unit 304 using the control unit 301 and rearrange the record in the order of the date and time when each jam occurred.

In step S1805, the CPU 201 displays the cross-sectional view 401 created by the display unit 302 in step S1803 and the jam screen 800 including the jam occurrence record created in step S1804. In the first embodiment, it is assumed that, if there is no location at which a jam is currently occurring and the location at which jams frequently occur (step S1802: NO), a cross-sectional view 401 with no icons mapped thereto is displayed. However, if there is no icon to be mapped, the CPU 201 may hide the cross-sectional view 401 and display a message indicating that there is no location at which a jam is currently occurring or at which jams frequently occur.

As described above, FIG. 12 is a diagram showing an example of the jam screen. FIG. 12 shows the cross-sectional view 401 to which the location at which a jam is currently occurring and the location at which jams frequently occur are mapped, and the jam list 801 showing the jam record information. Here, if the reset button 803 has been pressed, the CPU 201 clears the icons and the jam list 801 mapped to the cross-sectional view 401 shown in FIG. 12. Also, the CPU 201 clears only the jam list 801 to be displayed, and does not delete the record stored in step S1703.

In step S1806, the CPU 201 uses the control unit 301 to determine whether or not pressing of the button for displaying the details screen of the jam occurrence record has been detected. Here, whether or not the pressing of the button is detected is assumed to be whether or not any in the jam lists 801 shown in FIG. 12 has been pressed and then the jam details button 802 has been pressed, but it may be whether or not any in the jam list 801 has been pressed.

If it is determined that pressing of the button for displaying the details screen of the jam occurrence record has not been detected (step S1806: NO), the CPU 201 ends the process. On the other hand, if it is determined that pressing of the button for displaying the details screen of the jam occurrence record has been detected (step S1806: YES), the CPU 201 advances the process to step S1807.

In step S1807, the CPU 201 uses the control unit 301 to acquire the record of the jams that have occurred at the location selected by the user from the record management unit 304 and rearrange the record in order of the occurrence date and time.

In step S1808, the CPU 201 displays the records of each jam that occurred at the location selected by the display 302 as the jam details screen 810.

As described above, FIG. 13 is a diagram showing an example of the jam details screen, and shows a screen when the serviceman selects a second jam record from the top in the jam list 801 shown in FIG. 12. In FIG. 13, the cumulative occurrence number of jams is 25, and thus individual records of the 25 jams are displayed. In the first embodiment, the paper feed position, the paper feed counter, the paper feed size, and the like are displayed on the details screen as the paper information, but the paper information is not limited thereto as long as it is paper information required for dealing with jams.

Also, in the first embodiment, the screen transitions from the jam screen 800 as shown in FIG. 12 and displays the jam details screen 810 as shown in FIG. 13 as a separate screen, but the screen configuration is not limited thereto. For example, the CPU 201 may display the records of the jams that have occurred and the jam details on the same screen, or may display the jam details screen 810 as a pop-up screen if the display area for the records of the jams that have occurred is operated.

By executing the above processes, the CPU 201 visualizes the location at which a jam is currently occurring and the location at which jams frequently occur using the cross-sectional view 401, and displays them together with the dates and times when the jams have occurred and the details of the detected jams as the jam occurrence record. In addition, in the jam details screen 810, individual records of the jams that have occurred in the same location are displayed.

Thus, the serviceman can get an overview of the cross-sectional view 401 to which the location at which a jam is currently occurring and the location at which jams frequently occur are mapped, the dates and times when the jams have occurred, and the details of the detected jams. In addition, this makes it possible for the serviceman to recognize time intervals of the jams that have occurred at the same location, paper information, and the like. Accordingly, the serviceman can easily identify the cause of a jam and quickly respond the jam.

Also, a method of displaying “0” for the location at which no jam occurred, or displaying the same mark for the location at which a jam is currently occurring and for the location at which jams frequently occur, but in different colors (for example, green) may be used. However, unlike such a configuration, in the first embodiment, mapping is performed only for the locations at which jams have occurred. For this reason, the location that needs to be addressed is clearly displayed.

Also, in the present embodiment, the details of the jam occurrence record can be displayed in each of a transport path for transporting the document scanned by the document reading unit and a transport path for transporting the paper to be printed, but the present invention may be configured to display only one of these transport paths.

### Second Embodiment

In the first embodiment, as the jam occurrence record, the dates and times when the jams have occurred and the contents of the detected jams have been displayed in the order of the date and time when each jam occurred, along with the cross-sectional view 401 to which the location at which a jam is currently occurring and the location at which jams frequently occur are mapped. Thus, in the first embodiment, the serviceman can get an overview of and see the locations at which the jams have occurred and the contents of the jam record. However, in the present invention, the record of the locations mapped to the cross-sectional view 401 may be displayed at the top in accordance with the dates and times the jams have occurred and the contents of the detected jams.

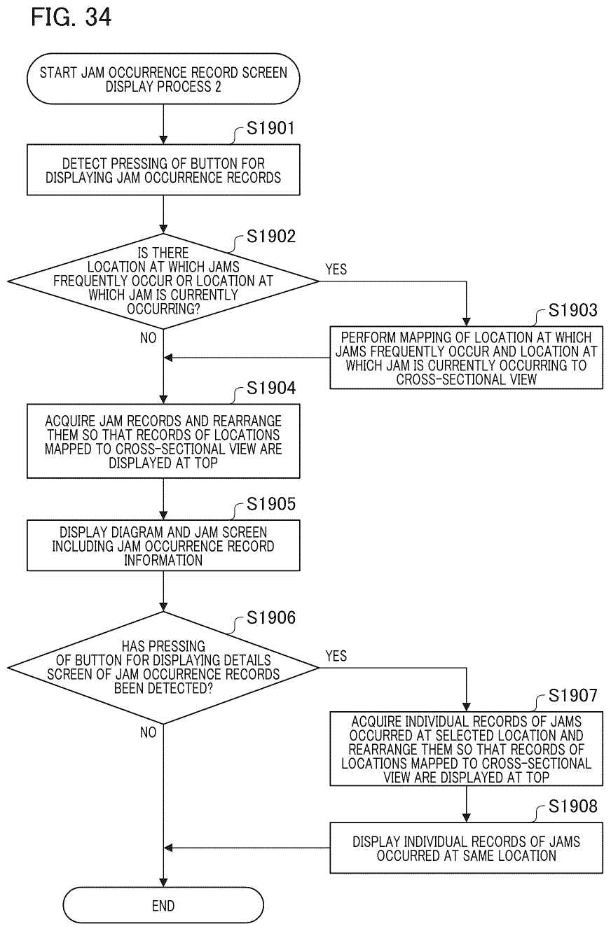

In a second embodiment, a method of displaying a record of locations mapped to the cross-sectional view 401 at the top on the jam screen 800 as shown in FIG. 12 to allow immediate check of a record of locations that require a response to jams will be described as an example. Also, unlike the first embodiment in which the process of displaying the jam screen 800 is executed in accordance with the flowchart shown in FIG. 33, the second embodiment executes the process in accordance with the flowchart shown in FIG. 34.

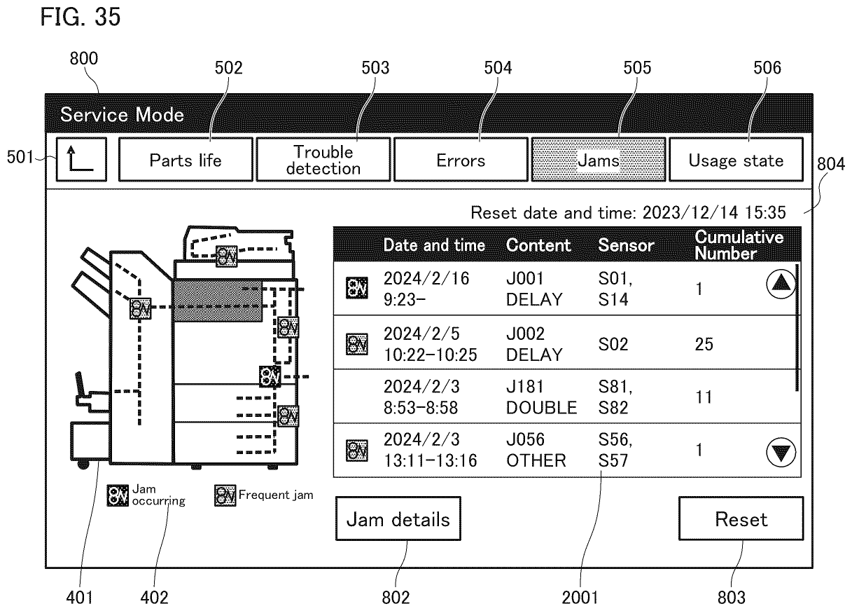

The process of displaying the jam screen 800 in the second embodiment will be described below with reference to FIGS. 34 and 35. FIG. 34 is a flowchart for described the process of displaying the jam screen according to the second embodiment.

In step S1901, the CPU 201 detects whether or not a button for displaying the jam occurrence record has been pressed using the operation unit 212. Also, in the second embodiment, as in the first embodiment, a scene of detecting whether the jams 406 shown in FIG. 4 or FIG. 5, or the jam button 505 shown in FIG. 6 has been pressed is assumed.

In step S1902, the CPU 201 uses the control unit 301 to determine whether or not the jam occurrence record stored in the record management unit 304 includes the location at which a jam is currently occurring or the at which jams frequently occur. If it is determined that the jam occurrence record stored in the record management unit 304 includes the location at which a jam is currently occurring or the location at which jams frequently occur (step S1902: YES), the CPU 201 advances the process to step S1903. On the other hand, if it is determined that the jam occurrence record stored in the record management unit 304 does not include the location at which a jam is currently occurring or the location at which jams frequently occur (step S1902: NO), the CPU 201 advances the process to step S1904.

In step S1903, the CPU 201 performs mapping of the location at which a jam is currently occurring or the location at which jams frequently occur onto the cross-sectional view 401 of the image processing device 103.

In step S1904, the CPU 201 uses the control unit 301 to acquire the jam occurrence record stored in the record management unit 304, and uses the control unit 301 to rearrange the record so that the record of the locations mapped to the cross-sectional view 401 is displayed at the top.

In step S1905, the CPU 201 displays the jam screen 800 including the cross-sectional view 401 created in step S1903 and the jam occurrence record created in step S1904.

FIG. 35 is a diagram showing that the record of the locations mapped to the cross-sectional view of the image processing device is displayed at the top in the jam screen in the second embodiment. The jam screen 800 shown in FIG. 35 displays a jam list 2001 with the record of the locations mapped in the cross-sectional view 401 at the top.

In step S1906, the CPU 201 determines whether or not pressing of the button for displaying the details screen of jam occurrence record using the operation unit 212 has been detected. If it is determined that pressing of the button for displaying the details screen of the jam occurrence record using the operation unit 212 has not been detected (step S1906: NO), the CPU 201 ends the process. On the other hand, if it is determined that pressing of the button for displaying the details screen of the jam occurrence record using the operation unit 212 has been detected (step S1906: YES), the CPU 201 advances the process to step S1907.

In step S1907, the CPU 201 uses the control unit 301 to acquire records of jams that have occurred at the selected location from the record management unit 304, and uses the control unit 301 to rearrange the record so that the record of the locations mapped in the cross-sectional view 401 is displayed at the top.

In step S1908, the CPU 201 displays the records of individual jam that occurred at the selected location as the jam details screen.

In the second embodiment, instead of the process of displaying the jam occurrence record according to the first embodiment, the process of displaying the record of the locations mapped to the cross-sectional view 401 at the top of the jam screen 800 has been executed.

In the first embodiment, by rearranging and displaying the jams in the order of the date and time when each jam occurred, the serviceman can check the jams that have recently occurred, and the serviceman can promptly respond to prevent the occurrence of jams. On the other hand, in the second embodiment, as shown in FIG. 35, by displaying the record of the locations mapped to the cross-sectional view 401 at the top, the serviceman can check the record of the location that requires a jam response and quickly respond to the location.

### Third Embodiment

In the first embodiment, as the jam occurrence record, all jam records that have not been cleared are displayed in order of the occurrence date and time, along with the cross-sectional view of the image processing device 103 to which the location at which a jam is currently occurring and the locations at which jams frequently occur are mapped. Thus, in the first embodiment, the serviceman can get an overview of the locations at which the jams have occurred and the contents of the jam record. However, in the present invention, record information for only one selected location among the locations mapped to the cross-sectional view 401 may be displayed.

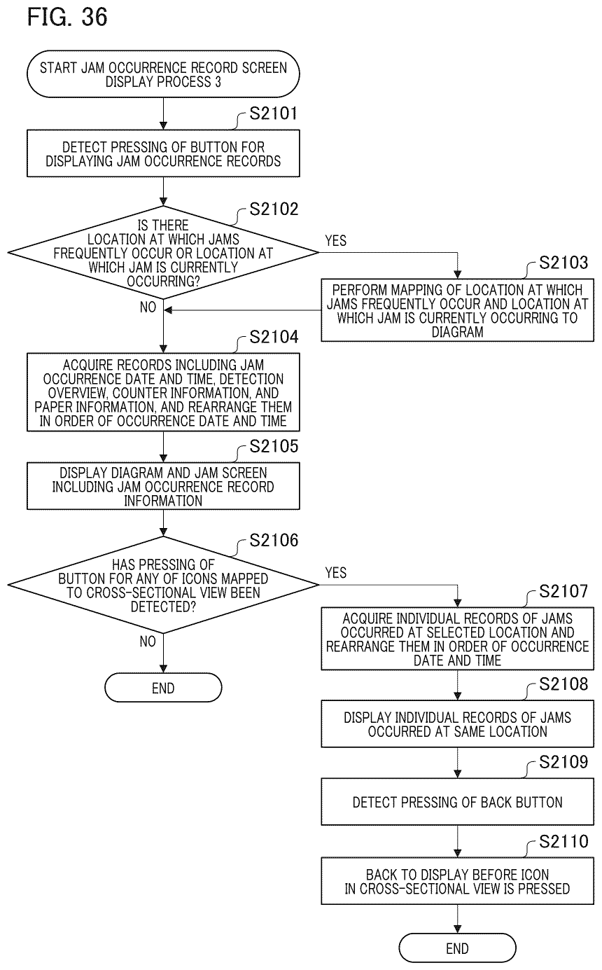

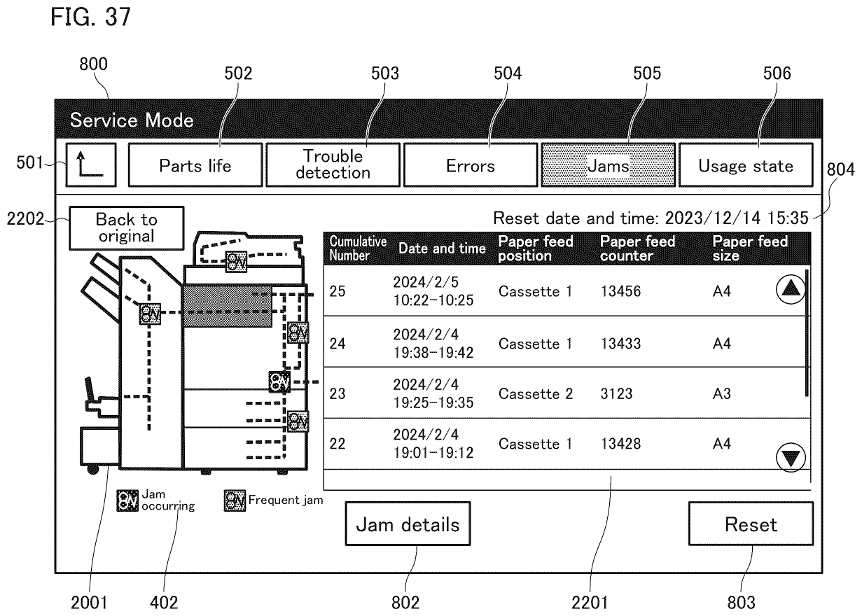

In a third embodiment, a method in which the serviceman selects any of the icons mapped to the cross-sectional view 401 on the jam screen 800 shown in FIG. 37 to display a record of the selected location instead of the jam details screen will be described as an example. Also, unlike the first embodiment in which the process of displaying the jam screen 800 using the display unit 302 is executed in accordance with the flowchart shown in FIG. 33, the third embodiment executes the process in accordance with the flowchart shown in FIG. 36.

A process of displaying the jam screen 800 in the third embodiment will be described below with reference to FIGS. 36 and 37. FIG. 36 is a flowchart for describing the process of displaying the jam screen according to the third embodiment.

In step S2101, the CPU 201 detects whether or not the button for displaying the jam occurrence record has been pressed using the operation unit 212. Also, in the third embodiment, as in the first embodiment, a scene of detecting whether or not the jams 406 shown in FIG. 4 or FIG. 5, or the jam button 505 shown in FIG. 6 has been pressed is assumed.

In step S2102, the CPU 201 uses the control unit 301 to determine whether or not the jam occurrence record stored in the record management unit 304 includes a location at which a jam is currently occurring or locations at which jams frequently occur. If it is determined that the jam occurrence record stored in the record management unit 304 includes the location at which a jam is currently occurring or the locations at which jams frequently occur (step S2102: YES), the CPU 201 advances the process to step S2103. On the other hand, if it is determined that the jam occurrence record stored in the record management unit 304 does not include the location the location at which a jam is currently occurring or the locations at which jams frequently occur (step S2102: NO), the CPU 201 advances the process to step S2104.

In step S2103, the CPU 201 performs mapping of the location at which a jam is currently occurring or the locations at which jams frequently occur on the cross-sectional view 401 of the image processing device 103.

In step S2104, the CPU 201 uses the control unit 301 to acquire the jam occurrence record stored in the record management unit 304, and uses the control unit 301 to rearrange the record so that the record of the locations mapped to the cross-sectional view 401 is displayed at the top.

In step S2105, the CPU 201 displays the jam screen 800 including the cross-sectional view 401 created in step S2104 and the jam occurrence record created in step S2104.

In step S2106, the CPU 201 determines whether or not pressing of a button corresponding to any of the icons mapped to the cross-sectional view 401 has been detected. If it is determined that pressing of the button corresponding to any of the icons mapped to the cross-sectional view 401 has not been detected (step S2106: NO), the CPU 201 ends the process. On the other hand, if it is determined that pressing of the button corresponding to any of the icons mapped to the cross-sectional view 401 has been detected (step S2106: YES), the CPU 201 advances the process to step S2107.

In step S2107, the CPU 201 uses the control unit 301 to acquire the record of jams that have occurred at the selected location from the record management unit 304, and uses the control unit 301 to rearrange the record in the order of the date and time when each jam occurred.

In step S2108, the CPU 201 displays the records of individual jam that occurred at the selected location as the jam details screen.

In the third embodiment, it is assumed that the jam screen 800 shown in FIG. 12 is displayed in step S2105 and the jam screen 800 shown in FIG. 37 is displayed in step S2108. FIG. 37 shows that the serviceman selects any of the icons mapped to the cross-sectional view of the image processing device in the jam screen to display the record of the jam that has occurred at the selected location in the third embodiment. Also, in the third embodiment, all the icons mapped on the jam screen 800 shown in FIG. 37 are displayed in step S2108, and the selected icon is displayed and highlighted. However, in the third embodiment, for example, only the selected icon for transition to step S2108 may be displayed.

In step S2109, the CPU 201 uses the control unit 301 to detect pressing of the back button. Also, in step S2109, the CPU 201 may use the control unit 301 to detect another pressing of the icon pressed in step S2106, instead of the pressing of the back button. In addition, in step S2109, if pressing of an icon different from the icon pressed in step S2106 is detected, the CPU 201 may display the jam record that occurred at the selected location again.

In step S2110, the CPU 201 returns to the display before the icon for the cross-sectional view 401 is pressed. That is, in step S2110, the CPU 201 displays the screen displayed in step S2105 again.

In the third embodiment, instead of the process of displaying the jam occurrence record according to the first embodiment, the process of displaying the record information for only one location selected by the serviceman among the locations mapped on the cross-sectional diagram 400 in the jam screen 800 has been executed.

In the first embodiment, the jam details screen 810 shown in FIG. 13 is displayed by the serviceman who presses one case of the record and the jam details button 802 on the jam screen 800 shown in FIG. 12. On the other hand, in the third embodiment, display of the record of the jams that have occurred at the same location is executed through the operation of the serviceman without changing the screen, as shown in FIG. 36, which reduces the number of operation steps as compared to the first embodiment, allowing for a more intuitive display.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-105923, filed July 1 2024, which is hereby incorporated by reference wherein in its entirety.

What is claimed is:

1. An image processing device comprising:
at least one processor; and
at least one memory holding a program that makes the processor function as:
a jam occurrence record display unit configured to display a screen of records of jams at at least one location in the image processing device; and
a jam details display unit configured to display details of individual records of jams that have occurred at the same location on the basis of a user operation on the screen of records of jams,
wherein
at least one of the jam occurrence record display unit and the jam details display unit displays at least one of dates and times when the jams have occurred and paper information about the paper on which the jams have occurred.

2. The image processing device according to claim 1, further comprising:
a jam occurring location determination unit configured to determine whether or not there is a location at which a jam is currently occurring; and
a frequent jam location determination unit configured to determine whether or not there is a location at which jams have occurred more than a predetermined number of times,
wherein
the jam occurrence record display unit visualizes the location at which jams have occurred more than the predetermined number of times if the location at which jams have occurred more than the predetermined number of times is determined to be present, and visualizes the location at which a jam is currently occurring if the location at which a jam is currently occurring is determined to be present.

3. The image processing device according to claim 1, wherein
the jam occurrence record display unit displays only the latest record at the location at which jams have occurred or the location at which a jam is currently occurring, and if an instruction to specify the locations at which jams have occurred or the location at which a jam is currently occurring and to display records other than the latest record is detected, displays individual records of jams at the location relating to the instruction.

4. The image processing device according to claim 1, wherein
the jam occurrence record display unit displays only the latest record at the locations at which jams have occurred or the location at which a jam is currently occurring, and if an operation on a display area in which information relating to the location at which jams have occurred more than a predetermined number of times or the location at which a jam is currently occurring is displayed is detected, displays individual records of jams at the location relating to the operation.

5. The image processing device according to claim 1, wherein
the jam occurrence record display unit displays jam record information indicating the records of jams in the order of the date and time when each jam occurred.

6. The image processing device according to claim 1, wherein
the jam occurrence record display unit displays jam record information indicating the records of jams at visualized locations at the top among the locations at which jams have occurred more than a predetermined number of times and at the location at which jams are currently occurring.

7. The image processing device according to claim 1, wherein
the jam occurrence record display unit displays at least one of the locations at which it is determined that jams have occurred more than a predetermined number of times and at which it is determined that a jam is currently occurring using an icon superimposed on a diagram of the image processing device.

8. The image processing device according to claim 1, wherein
the jam occurrence record display unit does not display anything on a diagram of the image processing device if there is no location at which it is determined that jams have occurred more than a predetermined number of times or at which a jam is currently occurring.

9. The image processing device according to claim 1, wherein
if there is no location at which it is determined that jams have occurred more than a predetermined number of times, the jam occurrence record display unit displays that there is no location at which it is determined that jams have occurred more than the predetermined number of times, and does not display the location at which jams have occurred more than the predetermined number of times.

10. The image processing device according to claim 1, wherein
if there is no location at which it is determined that a jam is currently occurring, the jam occurrence record display unit displays that there is no location at which it is determined that a jam is currently occurring, and does not display the location at which a jam is currently occurring.

11. A method for controlling an image processing device comprising:
a jam occurrence record display unit configured to display a screen of records of jams at at least one location in the image processing device; and
a jam details display unit configured to display details of individual records of jams that have occurred at the same location on the basis of a user operation on the screen of records of jams,
wherein
at least one of the jam occurrence record display unit and the jam details display unit displays at least one of dates and times when the jams have occurred and paper information about the paper on which the jams have occurred.

12. A non-transitory storage medium storing a computer program, configured to execute:
displaying a screen of records of jams at at least one location in an image processing device using a jam occurrence record display unit; and
displaying details of individual records of jams that have occurred at the same location on the basis of a user operation on the screen of records of jams using a jam details display unit,
wherein
at least one of the jam occurrence record display unit and the jam details display unit displays at least one of dates and times when the jams have occurred and paper information about the paper on which the jams have occurred.
